(19) United States
(12) Patent Application Publication
(10) Pub. No.: US 2015/0017416 A1
(43) Pub. Date: Jan. 15, 2015

(54) Composite Tapes and Rods Having Embedded Sensing Elements

(71) Applicant: Ticona LLC, Florence, KY (US)

(72) Inventors: Michael Ruby, Cincinnati, OH (US); David Eastep, Winona, MN (US); Aaron Johnson, Winona, MN (US); Ashish Sen, Winona, MN (US)

(21) Appl. No.: 14/321,153

(22) Filed: Jul. 1, 2014

Related U.S. Application Data
(60) Provisional application No. 61/841,963, filed on Jul. 2, 2013.

(51) Int. Cl. B29C 70/52

(52) U.S. Cl. CPC B29C 70/521; B29L 2031/3462
USPC 428/298.7; 428/394; 428/367; 428/395; 428/379; 428/298.1; 428/299.1; 428/299.4; 428/299.7

(57) ABSTRACT

Composite rods and tapes are provided. In one embodiment, a composite rod includes a core, the core including a thermoplastic material and a plurality of continuous fibers embedded in the thermoplastic material. The plurality of continuous fibers have a generally unidirectional orientation within the thermoplastic material. The core further includes one or more sensing elements embedded in the thermoplastic material. The core has a void fraction of about 5% or less. A sensing element may be, for example, fiber optic cable, a radio frequency identification transmitter, a copper fiber, or an aluminum fiber.

### CROSS REFERENCE TO RELATED APPLICATIONS

The present application claims filing benefit of U.S. Provisional Patent Application Ser. No. 61/841,963 having a filing date of Jul. 2, 2013, and which is incorporated herein by reference in its entirety.

### BACKGROUND OF THE INVENTION

Composite tapes and rods formed from fibers embedded in a polymer resin have been employed in a wide variety of applications. For example, such tapes, and more specifically rods formed from the tapes, may be utilized as lightweight structural reinforcements. One specific application of such rods is in the oil and gas industry, such as in subsea applications as well as in on-shore oil and gas production fields. In on-shore or subsea applications, for, example, multi-layer pipes may be utilized in risers, transfer lines, umbilicals and/or other suitable pipe assemblies. In production field applications, multi-layer pipes may be utilized in risers, infield flow lines, export pipelines and/or other suitable pipe assemblies. Power umbilicals, for example, are often used in the transmission of fluids and/or electric signals between the sea surface and equipment located on the sea bed. To help strengthen such umbilicals, attempts have been made to use pultruded carbon fiber rods as separate load carrying elements. Other applications of such rods may include, for example, use in high-voltage cables, tethers, etc. Applications of tapes may include, for example, use in high-pressure vessels to provide reinforcement thereof. In general, composite tapes and rods may be utilized in any suitable applications that may require, for example, high strength-to-weight elements, high corrosion resistance, and/or low thermal expansion properties.

There are many significant problems, however, with currently known methods and apparatus for producing composite tapes and rods. For example, composite tapes and rods are typically formed by impregnating fiber rovings with a polymer resin. Many rovings rely upon thermoset resins (e.g., vinyl esters) to help achieve desired strength properties. Thermoset resins are difficult to use during manufacturing and do not possess good bonding characteristics for forming layers with other materials. Further, attempts have been made to form impregnated rovings from thermoplastic polymers in other types of applications. U.S. Patent Publication No. 2005/0186410 to Bryant, et al., for instance, describes attempts that were made to embed carbon fibers into a thermoplastic resin to form a composite core of an electrical transmission cable. Unfortunately, Bryant, et al. notes that these cores exhibited flaws and dry spots due to inadequate wetting of the fibers, which resulted in poor durability and strength. Another problem with such cores is that the thermoplastic resins could not operate at a high temperature.

More recently, methods and apparatus have been developed that allow for the use of thermoplastic resins with fiber rovings to form composite tapes and rods. However, use of these presently known methods and apparatus has in some cases resulted in composite rods having undesirably high void levels. Additionally, presently known methods and apparatus are typically expensive and produce high levels of excess scrap.

Still further, monitoring of composite tapes and rods, and the components and applications in which the tapes and rods are employed, has become of increased concern. For example, in high pressure applications, it may be desirable to monitor the performance of the tapes and/or rods, such that the components utilizing the composite tapes and rods can be removed from service before significant damage or failure occurs. Further, in applicants wherein the tapes and/or rods are subjected to significant harmful exposure, such as in oil and gas applications, it may be similarly desirable to monitor the integrity and/or exposure of the tapes and/or rods, such that the components utilizing the composite tapes and rods can be removed from service before breaches in integrity or excessive exposure occur.

Accordingly, improved tapes and rods, as well as improved systems and methods for forming such composites, are desired in the art. Specifically, a need currently exists for tapes and rods having sensing characteristics which can monitor and report changes in performance, exposure, etc. of the tapes and rods. Further, a need currently exists for tapes and rods which have such sensing characteristics and further provide the desired strength, durability, temperature performance and dimensional requirements demanded by a particular application.

### SUMMARY OF THE INVENTION

In accordance with one embodiment of the present disclosure, a composite tape is disclosed. The composite tape includes a thermoplastic material and a plurality of continuous fibers embedded in the thermoplastic material. The plurality of continuous fibers having a generally unidirectional orientation within the thermoplastic material. The composite tape further includes a sensing element embedded in the thermoplastic material.

In accordance with another embodiment of the present disclosure, a composite rod is disclosed. The composite rod includes a core. The core includes a thermoplastic material and a plurality of continuous fibers embedded in the thermoplastic material. The plurality of continuous fibers having a generally unidirectional orientation within the thermoplastic material. The core further includes a sensing element embedded in the thermoplastic material. The core has a void fraction of about 5% or less.

Other features and aspects of the present invention are set forth in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of a pressure vessel according to one embodiment of the present disclosure;

FIG. 2 is a perspective view of a cable according to one embodiment of the present disclosure;

FIG. 3 is a schematic illustration of an impregnation system in accordance with one embodiment of the present disclosure;

FIG. 4 is a perspective view of a die in accordance with one embodiment of the present disclosure;

FIG. 5 is a cross-sectional view of the die shown in FIG. 4;

FIG. 6 is an exploded view of a manifold assembly and gate passage for a die in accordance with one embodiment of the present disclosure;

FIG. 7 is a perspective view of one embodiment of a second impregnation plate at least partially defining an impregnation zone in accordance with one embodiment of the present disclosure;

FIG. 8 is a close-up cross-sectional view of a portion of an impregnation zone in accordance with one embodiment of the present disclosure;

FIG. 9 is a close-up cross-sectional view of a downstream end portion of an impregnation zone in accordance with one embodiment of the present disclosure;

FIG. 10 is a perspective view of a land zone in accordance with one embodiment of the present disclosure;

FIG. 11 is a perspective view of a land zone in accordance with one embodiment of the present disclosure;

FIG. 12 is a perspective view of a guide assembly for guiding a sensing element into a tape in accordance with one embodiment of the present disclosure;

FIG. 13 is a schematic illustration of one embodiment of a pultrusion system that may be employed in the present invention;

FIG. 14 is a top cross-sectional view of one embodiment of various calibration dies that may be employed in accordance with the present invention;

FIG. 15 is a side cross-sectional view of one embodiment of a calibration die that may be employed in accordance with the present invention;

FIG. 16 is a front view of a portion of one embodiment of a calibration die that may be employed in accordance with the present invention;

FIG. 17 is a front view of one embodiment of forming rollers that may be employed in accordance with the present invention;

FIG. 18 is a side view of a impregnation die and consolidation die, including a tube utilized for embedding a sensor element, that may be employed in accordance with the present invention;

FIG. 19 is a side view of a impregnation die and consolidation die, including a pipe utilized to facilitate embedding of a sensor element, that may be employed in accordance with the present invention;

FIG. 20 is a side view of a impregnation die, a consolidation die, and a calibration die, including a tube utilized for embedding a sensor element, that may be employed in accordance with the present invention;

FIG. 21 is a perspective view of a consolidation passage for use in embedding of a sensor element that may be employed in accordance with the present invention;

FIG. 22 is a perspective view of an alternative consolidation passage for use in embedding of a sensor element that may be employed in accordance with the present invention;

FIG. 23 is a perspective view of a tape in accordance with one embodiment of the present disclosure;

FIG. 24 is a cross-sectional view a tape in accordance with one embodiment of the present disclosure; and

FIG. 25 is a perspective view of a composite rod formed according to one embodiment of the present disclosure; and

Repeat use of reference characters in the present specification and drawings is intended to represent the same or analogous features or elements of the present invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention.

Generally speaking, the present disclosure is directed to tapes and rods having sensing elements embedded therein. The sensing elements may advantageously monitor and report changes in the performance and/or exposure of the tapes and/or rods, and the components utilizing the tapes and/or rods. Additionally or alternatively, the sensing elements may monitor and report changes in the environment to which the tapes, rods and/or components are subjected. Such monitoring and reporting may allow for the tapes, rods, and components to be removed from service, repaired, or otherwise adjusted before failure. Additionally or alternatively, such monitoring may allow for adjustments to be made to other components utilized in various applications to compensate for any reported changes in performance, exposure, or environment as required.

A tape or rod formed according to the present disclosure includes a continuous fiber reinforced thermoplastic (“CFRT”) material. The CFRT material includes a thermoplastic material and a plurality of continuous fibers embedded therein. Suitable thermoplastic materials for use in tapes and rods according to the present disclosure include, for instance, polyolefins (e.g., polypropylene, propylene-ethylene copolymers, etc.), polyesters (e.g., polybutylene terephalate (“PBT”)), polycarbonates, polyamides (e.g., PA12, Nylon™), polyether ketones (e.g., polyether ether ketone (“PEEK”)), polyetherimides, polyarylene ketones (e.g., polyphenylene diketone (“PPDK”)), liquid crystal polymers, polyarylene sulfides (e.g., polyphenylene sulfide (“PPS”), poly(biphenylene sulfide ketone), poly(phenylene sulfide diketone), poly(biphenylene sulfide), etc.), fluoropolymers (e.g., polytetrafluoroethylene-perfluoromethylvinylether polymer, perfluoro-alkoxyalkane polymer, petrafluoroethylene polymer, ethylene-tetrafluoroethylene polymer, etc.), polyacetals, polyurethanes, polycarbonates, styrenic polymers (e.g., acrylonitrile butadiene styrene (“ABS”)), and so forth.

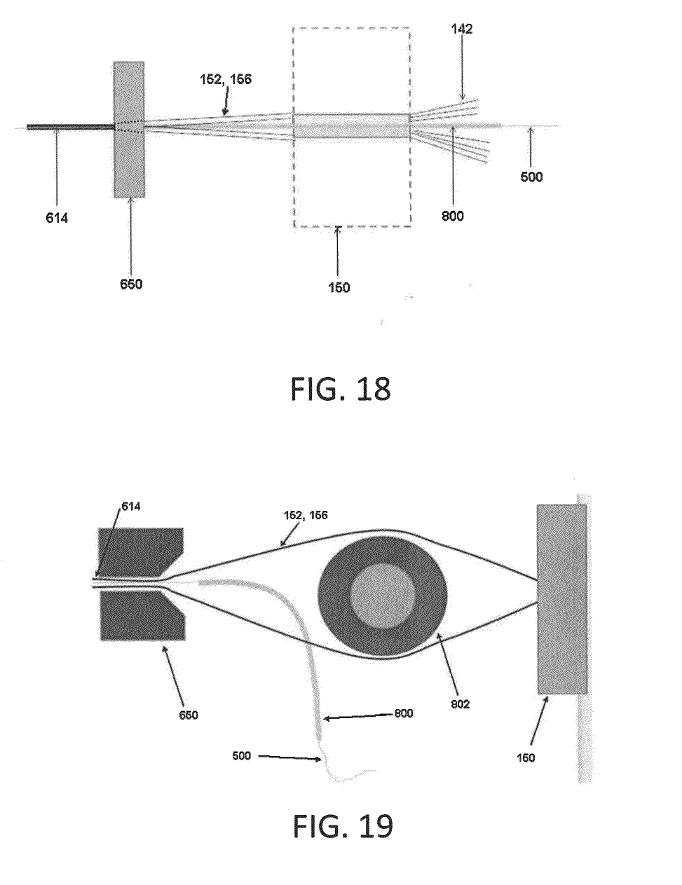

The thermoplastic material according to the present disclosure may further include a plurality of fibers embedded therein to reinforce the thermoplastic material. In exemplary embodiments, the CFRT material includes continuous fibers, although it should be understood that long fibers may additionally be included therein. The fibers may be dispersed in the thermoplastic material to form the CFRT material. As used therein, the term “long fibers” generally refers to fibers, filaments, yarns, or rovings that are not continuous, and as opposed to “continuous fibers” which generally refer to fibers, filaments, yarns, or rovings having a length that is generally limited only by the length of a part. The fibers dispersed in the polymer material may be formed from any conventional material known in the art, such as metal fibers, glass fibers (e.g., E-glass, A-glass, C-glass, D-glass, AR-glass, R-glass, S-glass such as S1-glass or S2-glass), carbon fibers (e.g., graphite), boron fibers, ceramic fibers (e.g., alumina or silica), aramid fibers (e.g., Kevlar® marketed by E. I. duPont de Nemours, Wilmington, Del.), synthetic organic fibers (e.g., polyamide, polyethylene, paraphenylene, terephthalamide, polyethylene terephthalate and polyphenylene sulfide), and various other natural or synthetic inorganic or organic fibrous materials known for reinforcing polymer compositions. Glass fibers, carbon fibers, and aramid fibers are particularly desirable. In exemplary embodiments, the continuous fibers may be generally unidirectional, as shown in FIG. 18.

A tape or rod according to the present disclosure further includes one or more sensing elements embedded therein. Each sensing element is embedded in the thermoplastic material, and is configured to monitor and/or report changes in performance of the tape and/or rod. In some embodiments, a sensing element may be, for example, a fiber optic cable. Alternatively, a sensing element may be a radio frequency identification (“RFID”) transmitter. Still further, a sensing element may be a copper fiber, aluminum fiber, or other suitable metal or metal alloy fiber. Still further, a sensing element may be, for example, a conducting liquid sensing cable, a water sensing cable, a fuel or oil sensing cable, or a liquid organic solvent cable, examples of which may be found from CAS Systems Limited of Tsuen Wan, NT, Hong Kong. When a change in performance of, exposure of, or environment surrounding a tape or rod occurs, properties of the sensing element may change. Such properties may include, for example, electrical signal (such as for example voltage), optical signal strength, light amplitude interferometry, micro-tension, and passive radio frequency signal strength. Additional such properties, which may be measure directly or, preferably, indirectly based on for example the above-listed properties, include displacement, strain, temperature, and pH level. These changes in properties may be monitored and correlated such that changes in performance, exposure or environment are received from these property changes. Use of sensing elements according to the present disclosure thus allows for tapes, rods, components utilizing the tapes and/or rods, and/or other components in an application thereof to be removed, repaired, replaced, and/or adjusted.

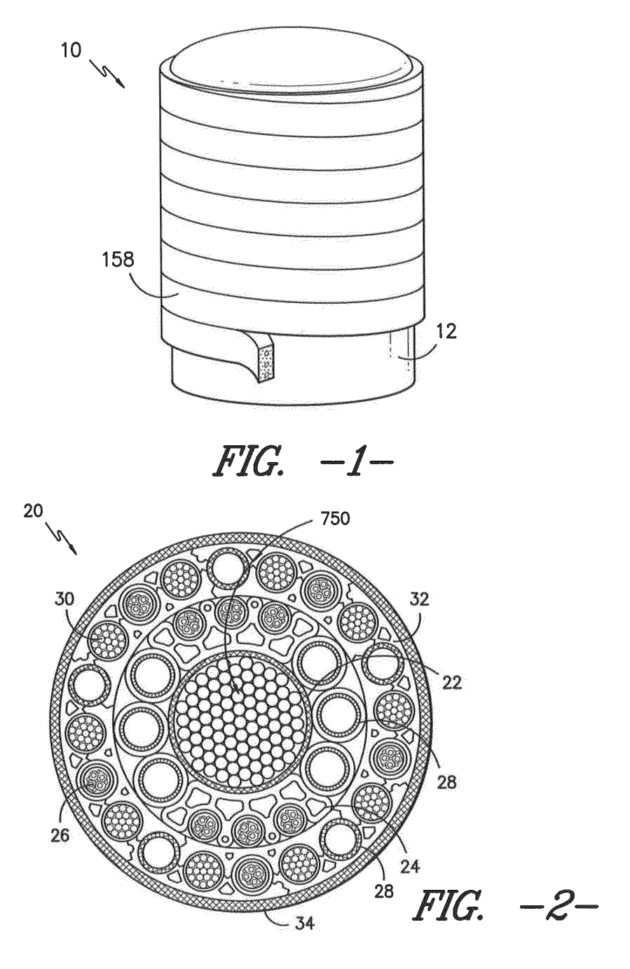

One embodiment of an application utilizing a tape 158 according to the present disclosure is shown in FIG. 1. In this embodiment, a pressure vessel 10 having a sidewall 12 is provided. A tape 158 formed according to the present disclosure is wrapped around the pressure vessel 10, such as around the sidewall 12, to reinforce the pressure vessel 10. Increased pressure ratings due to increased strength, and in this embodiment in particular increased hoop strength, are provided by the tape 158. The tape 158 may be wrapped circumferentially, helically, or in any other manner as desired or required. Further, the tape 158 may be heated to facilitate consolidation and bonding with the pressure vessel and, after application thereon, cooled to further facilitate consolidation and bonding.

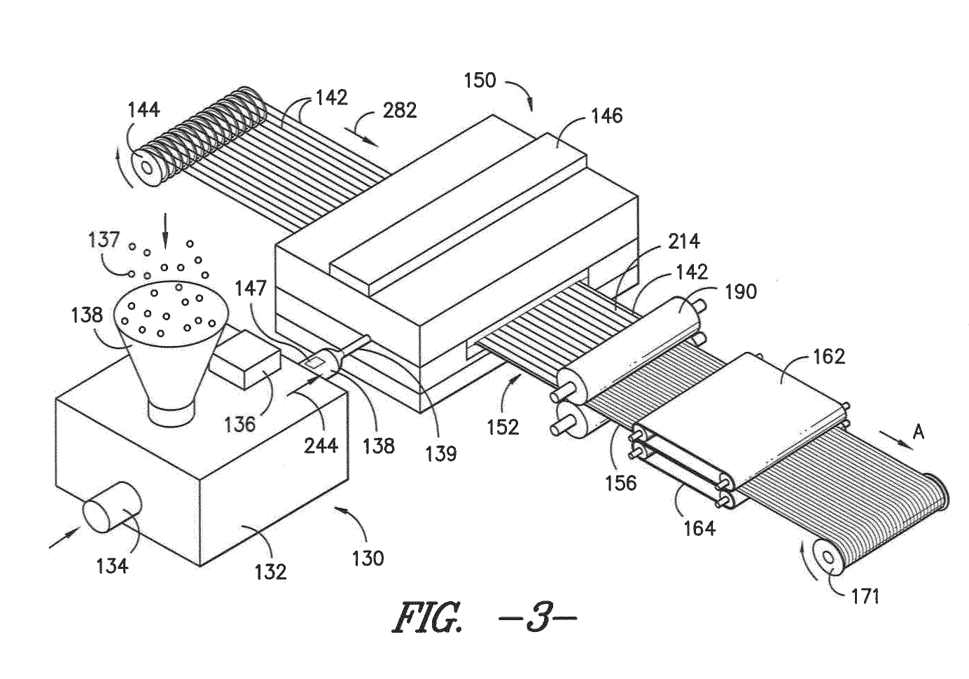

One embodiment of an application utilizing a rod 750 according to the present disclosure is shown in FIG. 2. In this embodiment, a cable 20, which in this case is an umbilical, is provided. This particular embodiment contains a central portion 22, which may be formed from a steel pipe, rubber sheath, metallic strand, metallic strand over-sheathed with a thermoplastic material, etc. One or more inner channel elements 24 (e.g., polyvinylchloride), electric conductors/wires 26 (e.g., optic fiber cables), and/or fluid pipes 28 (e.g., steel) may be concentrically disposed about the central portion 22. For example, such umbilical elements may be wound helically around the central portion 22 using a helix machine as is known in the art. The cable 20 may also contain conventional strength elements 30, such as those made from steel rope or armoring wires. A filler 32 (e.g., foam or thermoplastic material) may be arranged at least partly around and between two or more of the umbilical elements. An outer sheath 34 (e.g., polyethylene) also typically encloses the umbilical elements.

Rods 750 of the present disclosure may be incorporated into the cable 20 in any desired manner, such as individually or in the form of bundles. In the embodiment illustrated in FIG. 2, a bundle of reinforcing rods is disposed within the central portion 22 to provide enhanced strength to the umbilical 20. At least one, but preferably all of the rods are rods 750 formed from a CFRT material in accordance with the present disclosure. Of course, the rods need not be contained within the central portion of the umbilical, and rather may have any suitable positioning within the cable 20 as shown or any other suitable cable.

Additionally, although not shown, it should be noted that tapes 158 formed according to the present disclosure may be wrapped around the cable 20 to reinforce the cable 20, similar to wrapping around a pressure vessel 10 as discussed above.

It should further be understood that the present disclosure is not limited to the above disclosed applications, and rather that tapes 158 and rods 750 formed according to the present disclosure may be utilized in any suitable applications.

A tape and rod according to the present disclosure may be formed using any suitable process or apparatus. Exemplary embodiments of suitable processes and apparatus, such as pultrusion processes and apparatus, for forming a tape and rod according to the present disclosure are discussed in detail below.

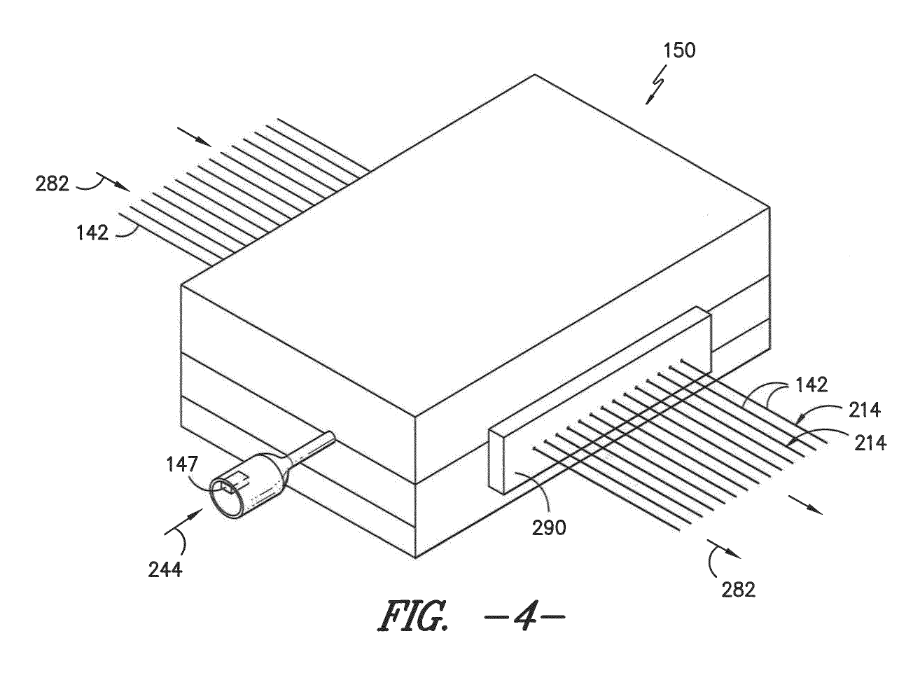

Referring to FIG. 3, one embodiment of such an extrusion device is shown. More particularly, the apparatus includes an extruder 130 containing a screw shaft 134 mounted inside a barrel 132. A heater 136 (e.g., electrical resistance heater) is mounted outside the barrel 132. During use, a feedstock 137 is supplied to the extruder 130 through a hopper 138. The feedstock is farmed from a thermoplastic material as discussed above. The feedstock 137 is conveyed inside the barrel 132 by the screw shaft 134 and heated by frictional forces inside the barrel 132 and by the heater 136. Upon being heated, the feedstock 137 exits the barrel 132 through a barrel flange 138 and enters a die flange 139 of an impregnation die 150.

A continuous fiber roving 142 or a plurality of continuous fiber ravings 142 are supplied from a reel or reels 144 to die 150. The ravings 142 are generally positioned side-by-side, with minimal to no distance between neighboring ravings, before impregnation. The feedstock 137 may further be heated inside the die by heaters 146 mounted in or around the die 150. The die is generally operated at temperatures that are sufficient to cause and/or maintain the proper melt temperature for the thermoplastic material, thus allowing for the desired level of impregnation of the rovings by the thermoplastic material. Typically, the operation temperature of the die is higher than the melt temperature of the thermoplastic material, such as at temperatures from about 200° C. to about 450° C. When processed in this manner, the continuous fiber rovings 142 become embedded in the thermoplastic material, which may be a resin 214 processed from the feedstock 137. The mixture may then exit the impregnation die 150 as wetted composite, extrudate, or tape 152.

As used herein, the term “roving” generally refers to a bundle of individual fibers 300. The fibers 300 contained within the roving can be twisted or can be straight. The rovings may contain a single fiber type or different types of fibers 300. Different fibers may also be contained in individual rovings or, alternatively, each roving may contain a different fiber type. The continuous fibers employed in the rovings possess a high degree of tensile strength relative to their mass. For example, the ultimate tensile strength of the fibers is typically from about 1,000 to about 15,000 Megapascals (“MPa”), in some embodiments from about 2,000 MPa to about 10,000 MPa, and in some embodiments, from about 3,000 MPa to about 6,000 MPa. Such tensile strengths may be achieved even though the fibers are of a relatively light weight, such as a mass per unit length of from about 0.05 to about 2 grams per meter, in some embodiments from about 0.4 to about 1.5 grams per meter. The ratio of tensile strength to mass per unit length may thus be about 1,000 Megapascals per gram per meter (“MPa/g/m”) or greater, in some embodiments about 4,000 MPa/g/m or greater, and in some embodiments, from about 5,500 to about 20,000 MPa/g/m. Carbon fibers are particularly suitable for use as the continuous fibers, which typically have a tensile strength to mass ratio in the range of from about 5,000 to about 7,000 MPa/g/m. The continuous fibers often have a nominal diameter of about 4 to about 35 micrometers, and in some embodiments, from about 9 to about 35 micrometers. The number of fibers contained in each roving can be constant or vary from roving to roving. Typically, a roving contains from about 1,000 fibers to about 50,000 individual fibers, and in some embodiments, from about 5,000 to about 30,000 fibers.

A pressure sensor 147 may sense the pressure near the impregnation die 150 to allow control to be exerted over the rate of extrusion by controlling the rotational speed of the screw shaft 134, or the feed rate of the feeder. That is, the pressure sensor 147 is positioned near the impregnation die 150, such as upstream of the manifold assembly 220, so that the extruder 130 can be operated to deliver a correct amount of resin 214 for interaction with the fiber rovings 142. After leaving the impregnation die 150, impregnated ravings 142 or the extrudate or tape 152, which may comprises the CFRT material, may enter an optional pre-shaping or guiding section (not shown) and/or a preheating device to control the temperature of the extrudate before entering a nip formed between two adjacent rollers 190. Although optional, the rollers 190 can help to consolidate the impregnated ravings 142 into a tape 156 or consolidate the tape 152 into a final tape 156, as well as enhance fiber impregnation and squeeze out any excess voids. In addition to the rollers 190, other shaping devices may also be employed, such as a die system. Regardless, the resulting consolidated tape 156 is pulled by tracks 162 and 164 mounted on rollers. The tracks 162 and 164 also pull the impregnated rovings 142 or tape 152 from the impregnation die 150 and through the rollers 190. If desired, the consolidated tape 156 may be wound up at a section 171. Generally speaking, the resulting tapes are relatively thin and typically have a thickness of from about 0.05 to about 1 millimeter, in some embodiments from about 0.1 to about 0.8 millimeters, and in some embodiments, from about 0.1 to about 0.4 millimeters.

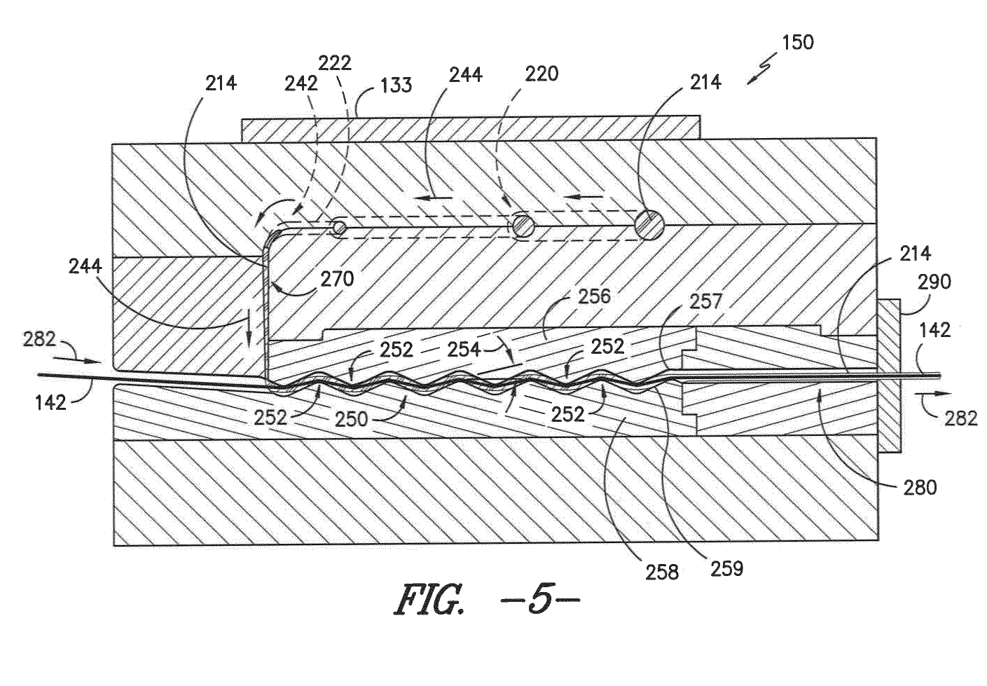

Perspective views of one embodiment of a die 150 according to the present disclosure are further shown in FIGS. 3 and 4. As shown, resin 214 is flowed into the die 150 as indicated by resin flow direction 244. The resin 214 is distributed within the die 150 and then interacted with the rovings 142. The rovings 142 are traversed through the die 150 in roving run direction 282, and are coated with resin 214. The rovings 142 are then impregnated with the resin 214, and these impregnated rovings 142 exit the die 150. In some embodiments, as shown in FIG. 3, the impregnated rovings 142 are connected by the resin 214 and thus exist as tape 152. In other embodiments, as shown in FIGS. 4 and 5, the impregnated ravings 142 exit the die separately, each impregnated within resin 214.

Within the impregnation die, it is generally desired that the ravings 142 are traversed through an impregnation zone 250 to impregnate the rovings with the polymer resin 214. In the impregnation zone 250, the polymer resin may be forced generally transversely through the rovings by shear and pressure created in the impregnation zone 250, which significantly enhances the degree of impregnation. This is particularly useful when forming a composite from tapes of a high fiber content, such as about 35% weight fraction (“Wf”) or more, and in some embodiments, from about 40% Wf or more. Typically, the die 150 will include a plurality of contact surfaces 252, such as for example at least 2, at least 3, from 4 to 7, from 2 to 20, from 2 to 30, from 2 to 40, from 2 to 50, or more contact surfaces 252, to create a sufficient degree of penetration and pressure on the rovings 142. Although their particular form may vary, the contact surfaces 252 typically possess a curvilinear surface, such as a curved lobe, pin, etc. The contact surfaces 252 are also typically made of a metal material.

FIG. 5 shows a cross-sectional view of an impregnation die 150. As shown, the impregnation die 150 includes a manifold assembly 220 and an impregnation section. The impregnation section includes an impregnation zone 250. In some embodiments, the impregnation section additionally includes a gate passage 270. The manifold assembly 220 is provided for flowing the polymer resin 214 therethrough. For example, the manifold assembly 220 may include a channel 222 or a plurality of channels 222. The resin 214 provided to the impregnation die 150 may flow through the channels 222.

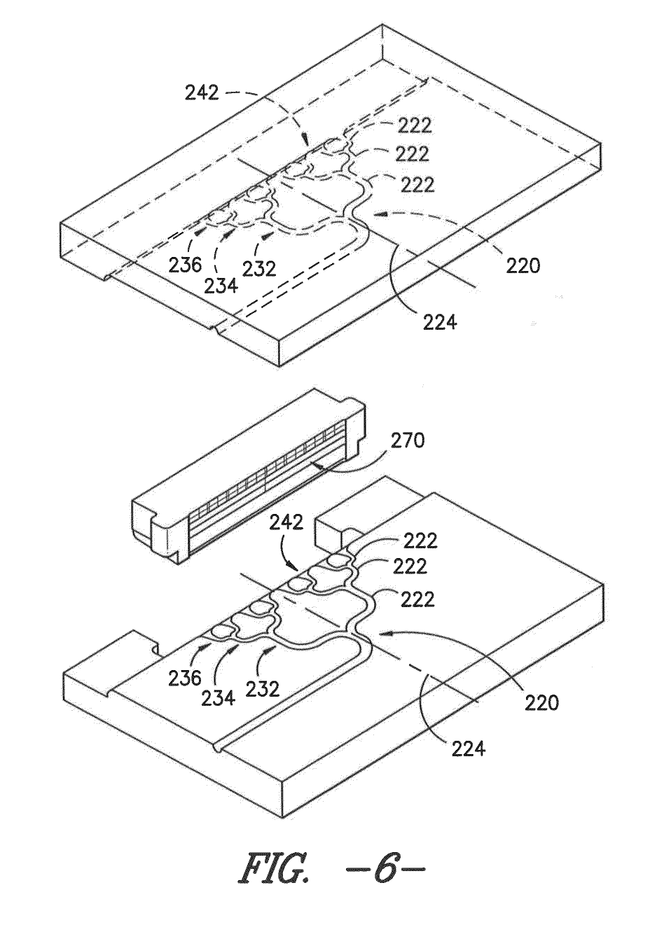

As shown in FIG. 6, in exemplary embodiments, at least a portion of each of the channels 222 may be curvilinear. The curvilinear portions may allow for relatively smooth redirection of the resin 214 in various directions to distribute the resin 214 through the manifold assembly 220, and may allow for relatively smooth flow of the resin 214 through the channels 222. Alternatively, the channels 222 may be linear, and redirection of the resin 214 may be through relatively sharp transition areas between linear portions of the channels 222. It should further be understood that the channels 222 may have any suitable shape, size, and/or contour.

The plurality of channels 222 may, in exemplary embodiments as shown in FIG. 6, be a plurality of branched runners 222. The runners 222 may include a first branched runner group 232. The first branched runner group 232 includes a plurality of runners 222 branching off from an initial channel or channels 222 that provide the resin 214 to the manifold assembly 220. The first branched runner group 232 may include 2, 3, 4 or more runners 222 branching off from the initial channels 222.

If desired, the runners 222 may include a second branched runner group 234 diverging from the first branched runner group 232, as shown. For example, a plurality of runners 222 from the second branched runner group 234 may branch off from one or more of the runners 222 in the first branched runner group 232. The second branched runner group 234 may include 2, 3, 4 or more runners 222 branching off from runners 222 in the first branched runner group 232.

If desired, the runners 222 may include a third branched runner group 236 diverging from the second branched runner group 234, as shown. For example, a plurality of runners 222 from the third branched runner group 236 may branch off from one or more of the runners 222 in the second branched runner group 234. The third branched runner group 236 may include 2, 3, 4 or more runners 222 branching off from runners 222 in the second branched runner group 234.

In some exemplary embodiments, as shown, the plurality of branched runners 222 have a symmetrical orientation along a central axis 224. The branched runners 222 and the symmetrical orientation thereof generally evenly distribute the resin 214, such that the flow of resin 214 exiting the manifold assembly 220 and coating the rovings 142 is substantially uniformly distributed on the rovings 142. This desirably allows for generally uniform impregnation of the ravings 142.

Further, the manifold assembly 220 may in some embodiments define an outlet region 242. The outlet region 242 is that portion of the manifold assembly 220 wherein resin 214 exits the manifold assembly 220. Thus, the outlet region 242 generally encompasses at least a downstream portion of the channels or runners 222 from which the resin 214 exits. In some embodiments, as shown, at least a portion of the channels or runners 222 disposed in the outlet region 242 have an increasing area in a flow direction 244 of the resin 214. The increasing area allows for diffusion and further distribution of the resin 214 as the resin 214 flows through the manifold assembly 220, which further allows for substantially uniform distribution of the resin 214 on the ravings 142. Additionally or alternatively, various channels or runners 222 disposed in the outlet region 242 may have constant areas in the flow direction 244 of the resin 214, or may have decreasing areas in the flow direction 244 of the resin 214.

In some embodiments, as shown, each of the channels or runners 222 disposed in the outlet region 242 is positioned such that resin 214 flowing therefrom is combined with resin 214 from other channels or runners 222 disposed in the outlet region 242. This combination of the resin 214 from the various channels or runners 222 disposed in the outlet region 242 produces a generally singular and uniformly distributed flow of resin 214 from the manifold assembly 220 to substantially uniformly coat the rovings 142. Alternatively, various of the channels or runners 222 disposed in the outlet region 242 may be positioned such that resin 214 flowing therefrom is discrete from the resin 214 from other channels or runners 222 disposed in the outlet region 242. In these embodiments, a plurality of discrete but generally evenly distributed resin flows 214 may be produced by the manifold assembly 220 for substantially uniformly coating the rovings 142.

As shown in FIG. 5, at least a portion of the channels or runners 222 disposed in the outlet region 242 have curvilinear cross-sectional profiles. These curvilinear profiles allow for the resin 214 to be gradually directed from the channels or runners 222 generally downward towards the rovings 142. Alternatively, however, these channels or runners 222 may have any suitable cross-sectional profiles.

As further illustrated in FIGS. 5 and 6, after flowing through the manifold assembly 220, the resin 214 may flow through gate passage 270. Gate passage 270 is positioned between the manifold assembly 220 and the impregnation zone 250, and is provided for flowing the resin 214 from the manifold assembly 220 such that the resin 214 coats the rovings 142. Thus, resin 214 exiting the manifold assembly 220, such as through outlet region 242, may enter gate passage 270 and flow therethrough.

In some embodiments, as shown in FIG. 5, the gate passage 270 extends vertically between the manifold assembly 220 and the impregnation zone 250. Alternatively, however, the gate passage 270 may extend at any suitable angle between vertical and horizontal such that resin 214 is allowed to flow therethrough.

Further, as shown in FIG. 5, in some embodiments at least a portion of the gate passage 270 has a decreasing cross-sectional profile in the flow direction 244 of the resin 214. This taper of at least a portion of the gate passage 270 may increase the flow rate of the resin 214 flowing therethrough before it contacts the rovings 142, which may allow the resin 214 to impinge on the rovings 142. Initial impingement of the rovings 142 by the resin 214 provides for further impregnation of the rovings, as discussed below. Further, tapering of at least a portion of the gate passage 270 may increase backpressure in the gate passage 270 and the manifold assembly 220, which may further provide more even, uniform distribution of the resin 214 to coat the ravings 142. Alternatively, the gate passage 270 may have an increasing or generally constant cross-sectional profile, as desired or required.

Upon exiting the manifold assembly 220 and the gate passage 270 of the die 150 as shown in FIG. 5, the resin 214 contacts the ravings 142 being traversed through the die 150. As discussed above, the resin 214 may substantially uniformly coat the ravings 142, due to distribution of the resin 214 in the manifold assembly 220 and the gate passage 270. Further, in some embodiments, the resin 214 may impinge on an upper surface of each of the ravings 142, or on a lower surface of each of the ravings 142, or on bath an upper and lower surface of each of the ravings 142. Initial impingement on the ravings 142 provides for further impregnation of the ravings 142 with the resin 214. Impingement on the rovings 142 may be facilitated by the velocity of the resin 214 when it impacts the rovings 142, the proximity of the rovings 142 to the resin 214 when the resin exits the manifold assembly 220 or gate passage 270, or other various variables.

As shown in FIG. 5, the coated ravings 142 are traversed in run direction 282 through impregnation zone 250. The impregnation zone 250 is in fluid communication with the manifold assembly 220, such as through the gate passage 270 disposed therebetween. The impregnation zone 250 is configured to impregnate the rovings 142 with the resin 214.

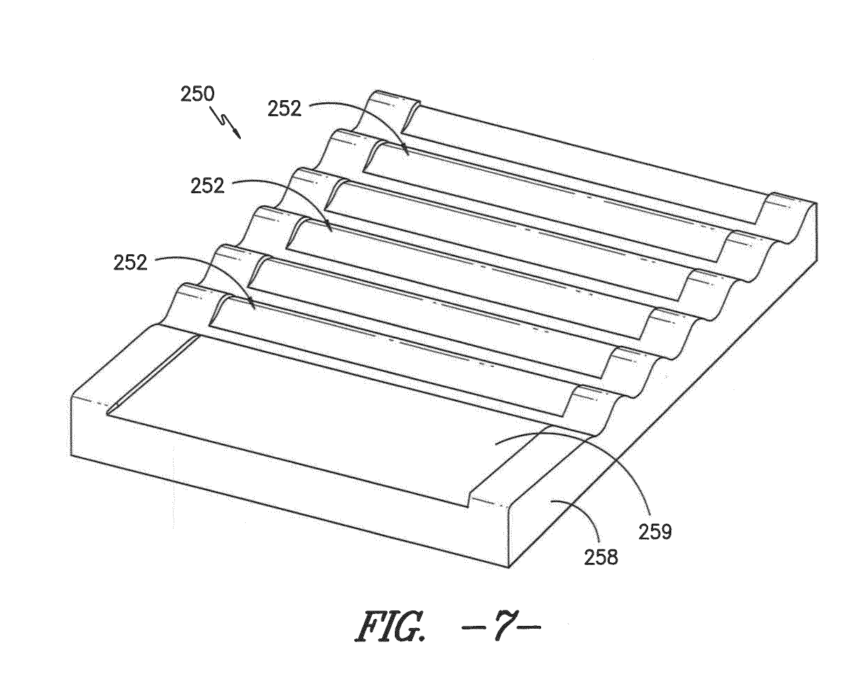

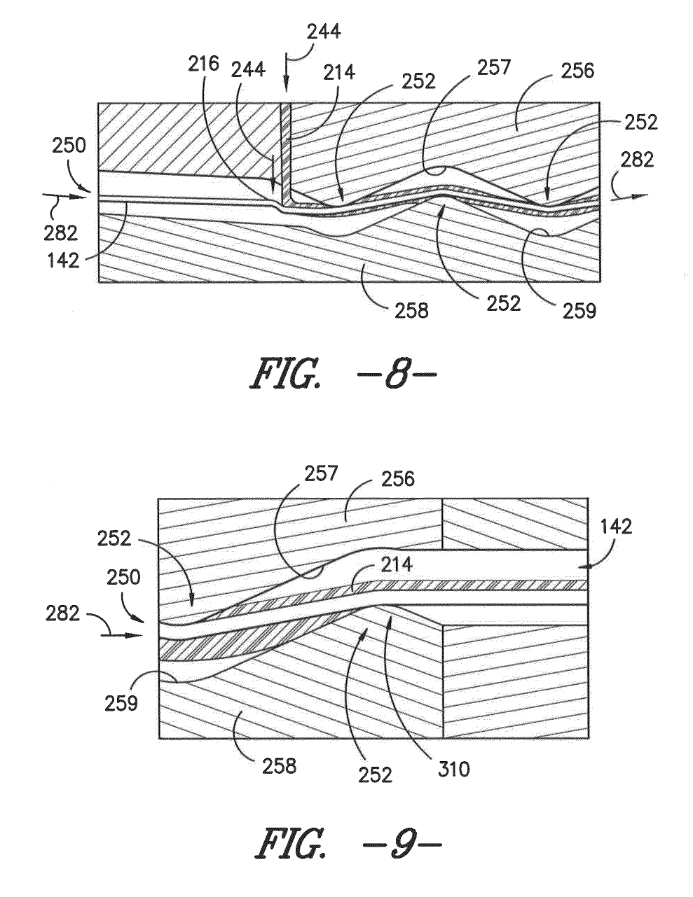

For example, as discussed above, in exemplary embodiments as shown in FIGS. 5 and 7 through 9, the impregnation zone 250 includes a plurality of contact surfaces 252. The ravings 142 are traversed over the contact surfaces 252 in the impregnation zone. Impingement of the ravings 142 on the contact surface 252 creates shear and pressure sufficient to impregnate the ravings 142 with the resin 214 coating the ravings 142.

In some embodiments, as shown in FIGS. 5, 8 and 9, the impregnation zone 250 is defined between two spaced apart opposing impregnation plates 256 and 258, which may be included in the impregnation section. First plate 256 defines a first inner surface 257, while second plate 258 defines a second inner surface 259. The impregnation zone 250 is defined between the first plate 256 and the second plate 258. The contact surfaces 252 may be defined on or extend from both the first and second inner surfaces 257 and 259, or only one of the first and second inner surfaces 257 and 259.

In exemplary embodiments, as shown in FIGS. 5, 8 and 9, the contact surfaces 252 may be defined alternately on the first and second surfaces 257 and 259 such that the rovings alternately impinge on contact surfaces 252 on the first and second surfaces 257 and 259. Thus, the ravings 142 may pass contact surfaces 252 in a waveform, tortuous or sinusoidual-type pathway, which enhances shear.

Angle 254 at which the rovings 142 traverse the contact surfaces 252 may be generally high enough to enhance shear and pressure, but not so high to cause excessive forces that will break the fibers. Thus, for example, the angle 254 may be in the range between approximately 1° and approximately 30° and in some embodiments, between approximately 5° and approximately 25°.

As stated above, contact surfaces 252 typically possess a curvilinear surface, such as a curved lobe, pin, etc. In exemplary embodiments as shown, a plurality of peaks, which may form contact surfaces 252, and valleys are thus defined. Further, in many exemplary embodiments, the impregnation zone 250 has a waveform cross-sectional profile. In one exemplary embodiment as shown in FIGS. 5 and 7 through 9, the contact surfaces 252 are lobes that form portions of the waveform surfaces of both the first and second plates 256 and 258 and define the waveform cross-sectional profile, FIG. 7 illustrates the second plate 258 and the various contact surfaces thereon that form at least a portion of the impregnation zone 250 according to some of these embodiments.

In other embodiments, the contact surfaces 252 are lobes that form portions of a waveform surface of only one of the first or second plate 256 or 258. In these embodiments, impingement occurs only on the contact surfaces 252 on the surface of the one plate. The other plate may generally be flat or otherwise shaped such that no interaction with the coated ravings occurs.

In other alternative embodiments, the impregnation zone 250 may include a plurality of pins (or rods), each pin having a contact surface 252. The pins may be static, freely rotational (not shown), or rotationally driven. Further, the pins may be mounted directly to the surface of the plates defining the impingement zone, or may be spaced from the surface. It should be noted that the pins may be heated by heaters 143, or may be heated individually or otherwise as desired or required. Further, the pins may be contained within the die 150, or may extend outwardly from the die 150 and not be fully encased therein.

In further alternative embodiments, the contact surfaces 252 and impregnation zone 250 may comprise any suitable shapes and/or structures for impregnating the ravings 142 with the resin 214 as desired or required.

As discussed, a roving 142 traversed through an impregnation zone 250 according to the present disclosure may become impregnated by resin 214, thus resulting in an impregnated roving 142, and optionally a tape 152 comprising at least one roving 142, exiting the impregnation zone 250, such as downstream of the contact surfaces 252 in the run direction 282. The impregnated rovings 142 and optional tape 152 exiting the impregnation zone 250 are thus formed from a fiber impregnated polymer material, as discussed above. At least one fiber roving 142 may be contained within a thermoplastic material, or resin, 214, as discussed above, to form the CFRT material and resulting tape 152 or tape 156.

As further shown in FIGS. 4 and 5, in some embodiments, a faceplate 290 may adjoin or be adjacent to the impregnation zone 250. The faceplate 290 may be positioned downstream of the impregnation zone 250 and, if included, the land zone 280, in the run direction 282. The faceplate 290 may contact other components of the die 150, such as the impregnation zone 250 or land zone 280, or may be spaced therefrom. Faceplate 290 is generally configured to meter excess resin 214 from the ravings 142. Thus, apertures in the faceplate 290, through which the ravings 142 traverse, may be sized such that when the ravings 142 are traversed therethrough, the size of the apertures causes excess resin 214 to be removed from the ravings 142.

As shown in FIG. 3, in alternative embodiments, the die 150 may lack a faceplate 290. Further, in some embodiments, the formation and maintenance of a tape 152 within and exited from a die 150 of the present disclosure may be facilitated through the lack of or removal of a faceplate from the die 150. Removal of the faceplate 290 allows for a plurality of rovings 142 exiting a die 150 to exit as a single sheet or tape 152, rather than as separated rovings 142 due to metering through the faceplate. This could potentially eliminate the need to later form these ravings 142 into such a sheet or tape 156. Removal of the faceplate 290 may have additional advantages. For example, removal may prevent clogging of the faceplate with resin 214, which can disrupt the traversal of ravings 142 therethrough. Additionally, removal may allow for easier access to the impregnation zone 250, and may thus make it easier to introduce and reintroduce rovings 142 to the impregnation zone 250 during start-up, after temporary disruptions such as due to breakage of a roving 142, or during any other suitable time period.

It should be understood that a tape 152, 156 according to the present disclosure may have any suitable cross-sectional shape and/or size. For example, such tape 152, 156 may have a generally rectangular shape, or a generally oval or circular or other suitable polygonal or otherwise shape. Further, it should be understood that one or more impregnated rovings 142 having been traversed through the impregnation zone 250 may together form the tape 152, 156, with the resin 214 of the various ravings 142 connected to form such tape 152, 156. The various above amounts, ranges, and/or ratios may thus in exemplary embodiments be determined for a tape 152 having any suitable number of impregnated rovings 142 embedded and generally dispersed within resin 214.

To further facilitate impregnation of the rovings 142, they may also be kept under tension while present within the die 150, and specifically within the impregnation zone 250. The tension may, for example, range from about 5 to about 300 Newtons, in some embodiments from about 50 to about 250 Newtons, and in some embodiments, from about 100 to about 200 Newtons per roving 142 or tow of fibers.

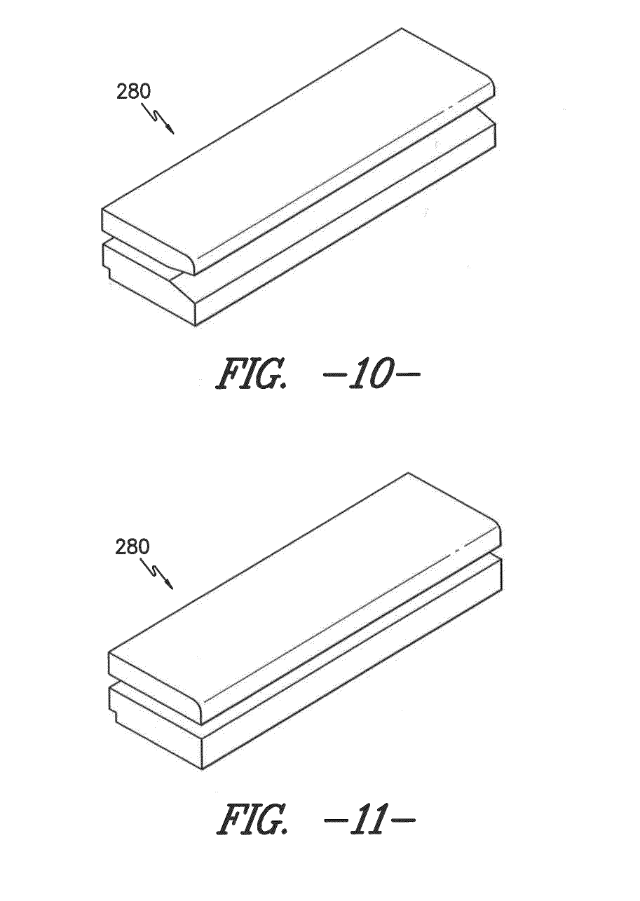

As shown in FIGS. 10 and 11, in some embodiments, a land zone 280 may be positioned downstream of the impregnation zone 250 in run direction 282 of the ravings 142. The ravings 142 may traverse through the land zone 280 before exiting the die 150. In some embodiments, as shown in FIG. 10, at least a portion of the land zone 280 may have an increasing cross-sectional profile in run direction 282, such that the area of the land zone 280 increases. The increasing portion may be the downstream portion of the land zone 280 to facilitate the rovings 142 exiting the die 150. Alternatively, the cross-sectional profile or any portion thereof may decrease, or may remain constant as shown in FIG. 11.

Additionally, other components may be optionally employed to assist in the impregnation of the fibers. For example, a “gas jet” assembly may be employed in certain embodiments to help uniformly spread a roving of individual fibers, which may each contain up to as many as 24,000 fibers, across the entire width of the merged tow. This helps achieve uniform distribution of strength properties. Such an assembly may include a supply of compressed air or another gas that impinges in a generally perpendicular fashion on the moving ravings that pass across exit ports. The spread rovings may then be introduced into a die for impregnation, such as described above.

It should be understood that tapes 152, 156 and impregnated ravings 142 thereof according to the present disclosure need not be formed in the dies 150 and other apparatus as discussed above. Such dies 150 and apparatus are merely disclosed as examples of suitable equipment for forming tapes 152, 156 or impregnated tows. The use of any suitable equipment or process to form tapes 152, 156 or impregnated tows is within the scope and spirit of the present disclosure.

Further, one or more sensing elements 500 may be embedded in the tape 152, 156, such that a tape 158 has a CFRT material and such sensing elements 500. Embedding of the sensing elements 500 may, in exemplary embodiments, be generally performed after a tape 152, 156 is initially formed, such as in a die 150, 412 as discussed above. Further, such embedding may, in exemplary embodiments, be generally performed while the tape 152, 156 is still in a generally molten form, before further forming and cooling of the tape 152, 156 occurs.

In some embodiments, a sensing element 500 may be embedded in a tape 152, 156 or, if the tape is being formed into a rods 750, a preform 614, such that the sensing element 500 bonds to the tape 152, 156 or preform 614 material, such as to the resin thereof. In other embodiments, the sensing element 500 may be unbonded from the tape 152, 156 or preform 614, such that the sensing element 500 can generally move independently within the tape 158, preform 614 or resulting rod 750 (discussed below). Various methods and apparatus may be utilized to embed sensing elements 500 such that they are bonded or unbonded, as desired per application of the resulting tape 158 or rod 750.

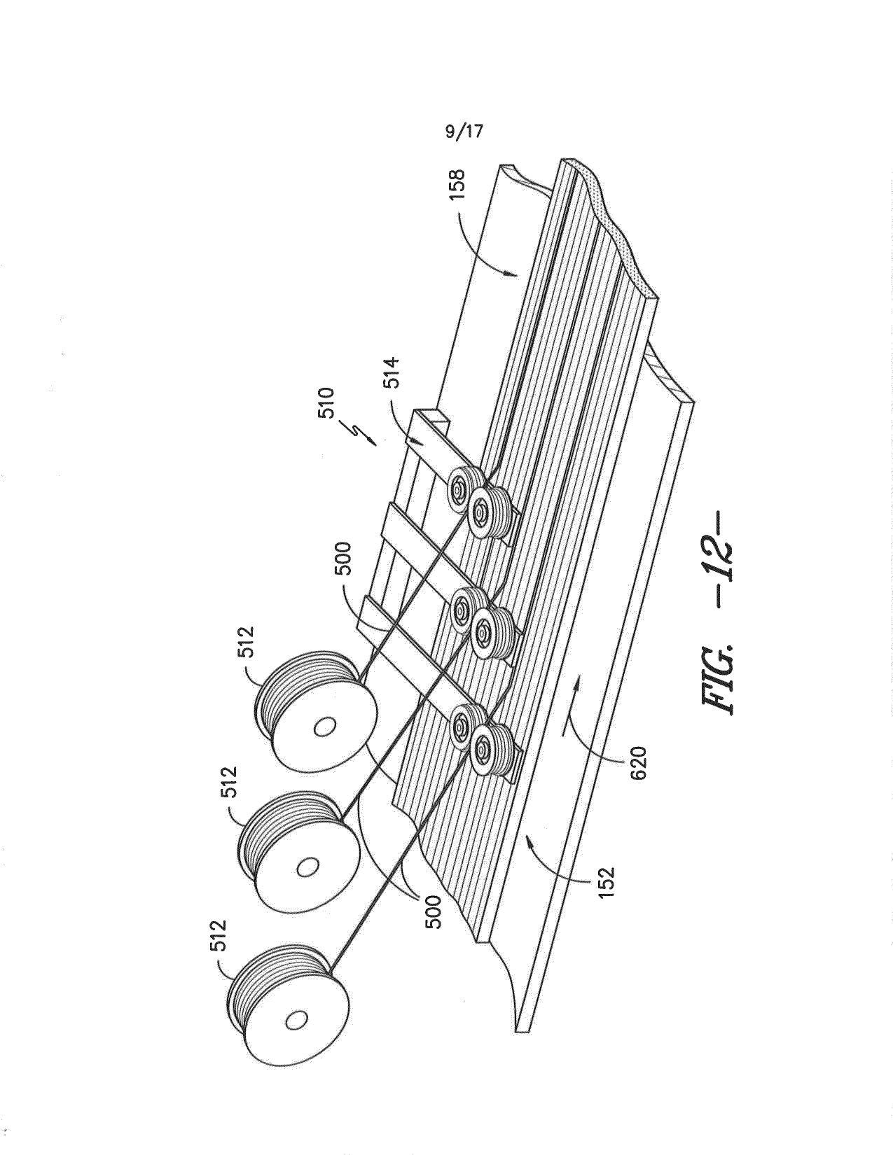

For example, FIG. 12 illustrates one embodiment of an apparatus for embedding a sensing element 500 in a tape 152, 156. A guide assembly 510 is shown for guiding a sensing element 500 into a tape 152, 156 such that the sensing element 500 becomes embedded therein. The guide assembly 510 may include, for example, a spool 512 or other suitable holding device for holding or containing the sensing elements 500. The guide assembly 510 may further include, for example, a plurality of guide rollers 514. The guide rollers 514 may be configured to guide the sensing elements 500 into contact with the tape 152, 156 such that the sensing elements 500 become embedded therein. For example, one or more sensing elements 500 may be traversed through a pair of guide rollers 514 positioned downstream of a die 150, 412. The sensing element 500 traversed through the guide rollers 514 may be contact and become embedded in the tape 152, 156. One or more pairs of guide rollers 514 may be positioned to guide one or more sensing elements 500 into contact with a tape 152, 156.

In some exemplary embodiments, a sensing element 500 may be a continuous fiber or cable. Alternatively, however, discrete sensing elements 500 that are not continuous may be individually embedded in the tape 152, 158. Further, in some exemplary embodiments wherein a plurality of sensing elements 500 are embedded, the sensing elements 500 may be generally unidirectional.

Further, sensing elements 500 may be embedded separately, as single elements, such as single fibers or cables, or alternatively may be embedded in bundles of sensing elements 500. Still further, the one or more sensing elements 500 may be assembled in a tube, which may for example be formed from a suitable metal or polymer material. The tube with the sensing element(s) embedded therein may be embedded as discussed herein.

A relatively high percentage of fibers may be employed in a tape, and CFRT material thereof, to provide enhanced strength properties. For instance, fibers typically constitute from about 25 wt. % to about 90 wt. %, in some embodiments from about 30 wt. % to about 75 wt. %, and in some embodiments, from about 35 wt. % to about 70 wt. % of the tape or material thereof. Likewise, polymer(s) typically constitute from about 20 wt % to about 75 wt. %, in some embodiments from about 25 wt. % to about 70 wt. %, and in some embodiments, from about 30 wt. % to about 65 wt. % of the tape 158. Such percentage of fibers may additionally or alternatively by measured as a volume fraction. For example, in some embodiments, the CFRT material may have a fiber volume fraction between approximately 25% and approximately 80%, in some embodiments between approximately 30% and approximately 70%, in some embodiments between approximately 40% and approximately 60%, and in some embodiments between approximately 45% and approximately 55%.

Embedding of a sensing element 500 in a CFRT material, such as in a tape 152, 156 as discussed above, may thus provide a composite tape 158. In some embodiments, the composite tape 158 may then be utilized as a tape in a particular application. The tape 158 may be cooled and stored for later use in such application, or may be immediately utilized in such application. A tape 158 in exemplary embodiments may be used in various applications by, for example, wrapping the tape 158 around a core material to reinforce the core material, such as illustrated in FIG. 18. The tape 158 may be heated in required to facilitate bonding and consolidation with the core material and other layers as required.

Alternatively, a tape 152, 156, 158 may be formed into a rod. Any suitable processes and apparatus may be utilized to form a tape 152, 156, 158 into a rod 750. The specific manner in which rovings and tapes 152, 156, 158 are shaped may be carefully controlled to ensure that rods 750 can be formed with an adequate degree of compression and strength properties. Referring to FIG. 13, for example, one particular embodiment of a system and method for forming a rod are shown. In this embodiment, two tapes 152, 156, 158 are initially provided in a wound package on a creel 620. The creel 620 may be an unreeling creel that includes a frame provided with horizontal spindles 622, each supporting a package. A pay-out creel may also be employed, particularly if desired to induce a twist into the fibers. It should also be understood that the tape may also be formed in-line with the formation of the rod. In one embodiment, for example, the tape 152, 156, 158 downstream of the guide assembly 510 may be directly supplied to the system used to form a rod. A tension-regulating device 640 may also be employed to help control the degree of tension in the tapes 152, 156, 158. The device 640 may include inlet plate 630 that lies in a vertical plane parallel to the rotating spindles 622 of the creel 620 and/or perpendicular to the incoming ribbons. The tension-regulating device 640 may contain cylindrical bars 641 arranged in a staggered configuration so that the tape 152, 156, 158 passes over and under these bars to define a wave pattern. The height of the bars can be adjusted to modify the amplitude of the wave pattern and control tension.

The tapes 152, 156, 158 may be heated in an oven 645 before entering a consolidation die. Heating may be conducted using any known type of oven, as in an infrared oven, convection oven, etc. During heating, the fibers in the tapes are unidirectionally oriented to optimize the exposure to the heat and maintain even heat across the entire tape. The temperature to which the tapes 152, 156, 158 are heated is generally high enough to soften the thermoplastic polymer to an extent that the tapes can bond together. However, the temperature is not so high as to destroy the integrity of the material. The temperature may, for example, range from about 100° C. to about 500° C., in some embodiments from about 200° C. to about 400° C., and in some embodiments, from about 250° C. to about 350° C. In one particular embodiment, for example, polyphenylene sulfide (“PPS”) is used as the polymer, and the tapes are heated to or above the melting point of PPS, which is about 285° C.

Upon being heated, the tapes 152, 156, 158 are provided to a consolidation die 650 that compresses them together into a preform 614, as well as aligns and forms the initial shape of the rod. As shown generally in FIG. 7, for example, the tapes 152, 156, 158 are guided through a flow passage 651 of the die 650 in a direction “A” from an inlet 653 to an outlet 655. The passage 651 may have any of a variety of shapes and/or sizes to achieve the rod configuration. For example, the channel and rod configuration may be circular, elliptical, parabolic, etc. Within the die 650, the ribbons are generally maintained at a temperature at or above the melting point of the thermoplastic matrix used in the ribbon to ensure adequate consolidation.

The desired heating, compression, and shaping of the tapes 152, 156, 158 may be accomplished through the use of a die 650 having one or multiple sections. For instance, although not shown in detail in FIG. 13, the consolidation die 650 may possess multiple sections that function together to compress and shape the tapes 152, 156, 158 into the desired configuration. For instance, a first section of the passage 651 may be a tapered zone that initially shapes the material as it flows from into the die 650. The tapered zone generally possesses a cross-sectional area that is larger at its inlet than at its outlet. For example, the cross-sectional area of the passage 651 at the inlet of the tapered zone may be about 2% or more, in some embodiments about 5% or more, and in some embodiments, from about 10% to about 20% greater than the cross-sectional area at the outlet of the tapered zone. Regardless, the cross-sectional of the flow passage typically changes gradually and smoothly within the tapered zone so that a balanced flow of the composite material through the die can be maintained. A shaping zone may also follow the tapered zone that compresses the material and provides a generally homogeneous flow therethrough. The shaping zone may also pre-shape the material into an intermediate shape that is similar to that of the rod, but typically of a larger cross-sectional area to allow for expansion of the thermoplastic polymer while heated to minimize the risk of backup within the die 650. The shaping zone could also include one or more surface features that impart a directional change to the preform. The directional change forces the material to be redistributed resulting in a more even distribution of the fiber/resin in the final shape. This also reduces the risk of dead spots in the die that can cause burning of the resin. For example, the cross-sectional area of the passage 651 at the shaping zone may be about 2% or more, in some embodiments about 5% or more, and in some embodiments, from about 10% to about 20% greater than the width of the preform 614. A die land may also follow the shaping zone to serve as an outlet for the passage 651. The shaping zone, tapered zone, and/or die land may be heated to a temperature at or above that of the glass transition temperature or melting point of the thermoplastic matrix.

If desired, a second die 660 (e.g., calibration die) may also be employed that compresses the preform 614 into the final shape of the rod. When employed, it is sometimes desired that the preform 614 is allowed to cool briefly after exiting the consolidation die 650 and before entering the optional second die 660. This allows the consolidated preform 614 to retain its initial shape before progressing further through the system. Typically, cooling reduces the temperature of the exterior of the rod below the melting point temperature of the thermoplastic matrix to minimize and substantially prevent the occurrence of melt fracture on the exterior surface of the rod. The internal section of the rod, however, may remain molten to ensure compression when the rod enters the calibration die body. Such cooling may be accomplished by simply exposing the preform 614 to the ambient atmosphere (e.g., room temperature) or through the use of active cooling techniques (e.g., water bath or air cooling) as is known in the art. In one embodiment, for example, air is blown onto the preform 614 (e.g., with an air ring). The cooling between these stages, however, generally occurs over a small period of time to ensure that the preform 614 is still soft enough to be further shaped. For example, after exiting the consolidation die 650, the preform 614 may be exposed to the ambient environment for only from about 1 to about 20 seconds, and in some embodiments, from about 2 to about 10 seconds, before entering the second die 660. Within the die 660, the preform is generally kept at a temperature below the melting point of the thermoplastic matrix used in the ribbon so that the shape of the rod can be maintained. Although referred to above as single dies, it should be understood that the dies 650 and 660 may in fact be formed from multiple individual dies (e.g., face plate dies).

Thus, in some embodiments, multiple individual dies 660 may be utilized to gradually shape the material into the desired configuration. The dies 660 are placed in series, and provide for gradual decreases in the dimensions of the material. Such gradual decreases allow for shrinkage during and between the various steps.

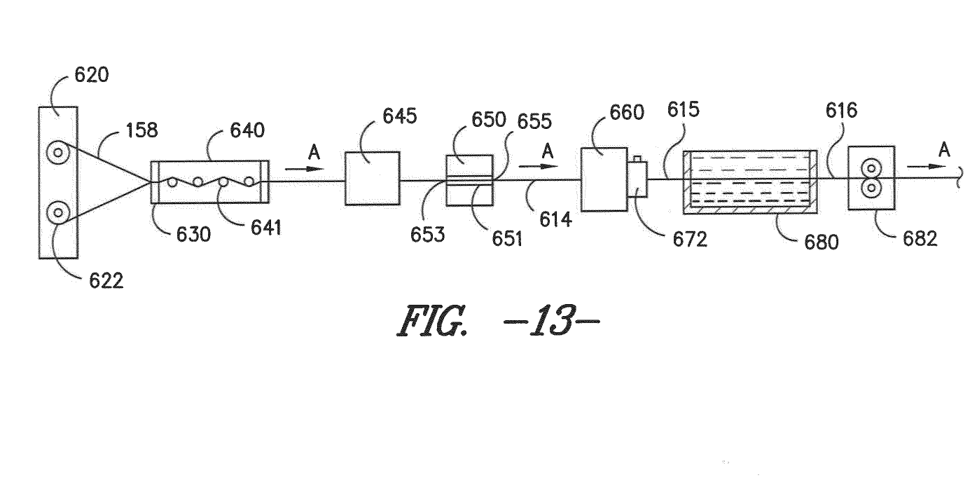

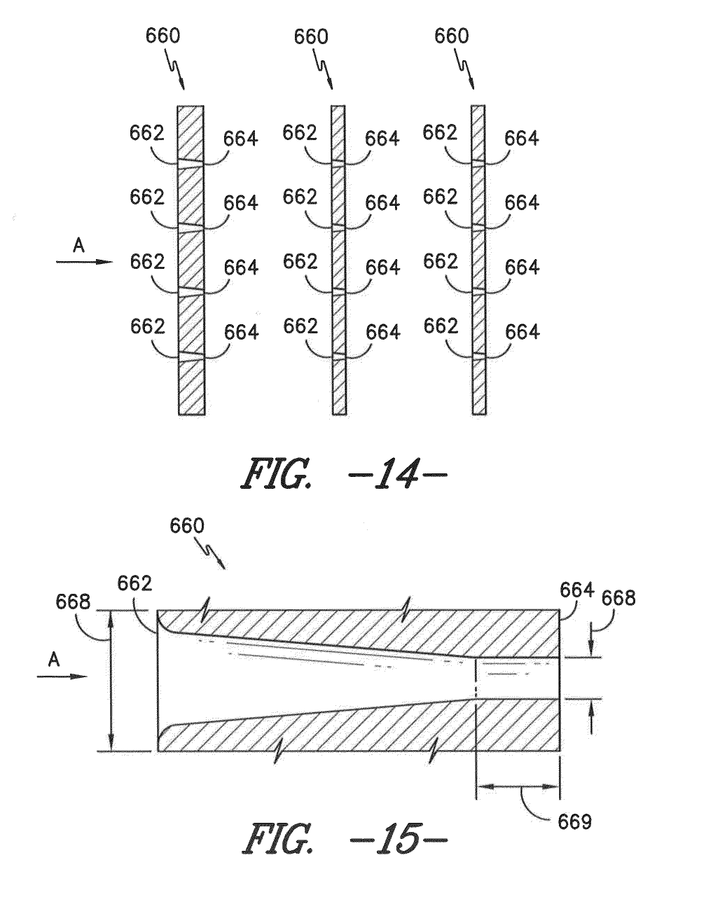

For example, as shown in FIGS. 14 through 16, a first die 660 may include one or more inlets 662 and corresponding outlets 664, as shown. Any number of inlets 662 and corresponding outlets 664 may be included in a die 660, such as four as shown, one, two, three, five, six, or more. An inlet 662 in some embodiments may be generally oval or circle shaped. In other embodiments, the inlet 662 may have a curved rectangular shape, i.e. a rectangular shape with curved corners or a rectangular shape with straight longer sidewalls and curved shorter sidewalls. Further, an outlet 664 may be generally oval or circle shaped, or may have a curved rectangular shape. In some embodiments wherein an oval shaped inlet is utilized, the inlet 662 may have a major axis length 666 to minor axis length 668 ratio in a range between approximately 3 to 1 and approximately 5 to 1. In some embodiments wherein an oval or circular shaped inlet is utilized, the outlet 664 may have a major axis length 666 to minor axis length 668 ratio in a range between approximately 1 to 1 and approximately 3 to 1. In embodiments wherein a curved rectangular shape is utilized, the inlet and outlet may have major axis length 666 to minor axis length 668 ratios (aspect ratios) between approximately 2 to 1 and approximately 7 to 1, with the outlet 664 ratio being less than the inlet 662 ratio.

In further embodiments, the cross-sectional area of an inlet 662 and the cross-sectional area of a corresponding outlet 664 of the first die 660 may have a ratio in a range between approximately 1.5 to 1 and 6 to 1.

The first die 660 thus provides a generally smooth transformation of polymer impregnated fiber material to a shape that is relatively similar to a final shape of the resulting rod, which in exemplary embodiments has a circular or oval shaped cross-section. Subsequent dies, such as a second die 660 and third die 660 as shown in FIG. 14, may provide for further gradual decreases and/or changes in the dimensions of the material, such that the shape of the material is converted to a final cross-sectional shape of the rod. These subsequent dies 660 may both shape and cool the material. For example, in some embodiments, each subsequent die 660 may be maintained at a lower temperature than the previous dies. In exemplary embodiments, all dies 660 are maintained at temperatures that are higher than a softening point temperature for the material.

In further exemplary embodiments, dies 660 having relatively long land lengths 669 may be desired, due to for example desires for proper cooling and solidification, which are critical in achieving a desired rod shape and size. Relatively long and lengths 669 reduce stresses and provide smooth transformations to desired shapes and sizes, and with minimal void fraction and bow characteristics. In some embodiments, for example, a ratio of land length 669 at an outlet 664 to major axis length 666 at the outlet 664 for a die 660 may be in the range between approximately 0 and approximately 20, such as between approximately 2 and approximately 6.

The use of calibration dies 660 according to the present disclosure provides for gradual changes in material cross-section, as discussed. These gradual changes may in exemplary embodiments ensure that the resulting product, such as a rod or other suitable product, has a generally uniform fiber distribution with relatively minimal void fraction.

It should be understood that any suitable number of dies 660 may be utilized to gradually form the material into a profile having any suitable cross-sectional shape, as desired or required by various applications.

As discussed above, a sensing element 500 may be embedded in a tape 152, 156 or, if the tape is being formed into a rods 750, a preform 614, in a bonded or unbonded state. Further embodiments are illustrated in, for example, FIGS. 18 through 22. As shown in FIG. 18, in one embodiment, a tube 800 may be extended through and/or between various dies, such as impregnation dies 150 and a consolidation die 650. Within the impregnation dies 150, for example, the tube 800 may extend above or beneath the impregnation zone, such as the plates thereof. The tube 800 may, for example, be formed from steel or another suitable metal, or alternatively from any suitable material. One or more sensing elements 500 may be extended through the tube 800. One or more tapes 152, 156 may be formed in impregnation dies 150, as discussed above. The tube 800 may orient the sensing element 500 relative to the tapes 152, 156, so that for example the sensing element 500 is generally centered or otherwise positioned relative to the tapes 152, 156 and within the resulting preform 614. As shown, the tube 800 may for example end at or within the inlet 662 to a die 660, such that sensing element 500 exits the tube 800 within the die 650. In exemplary embodiments, the tube 800 may further be positioned such that the sensing element 500 exits the tube 800 generally into the center of passage 651 of a die 650. As discussed above, consolidation of the one or more tapes 152, 156 may occur within the die 650 and passage 651 thereof, and the sensing element 500 may accordingly be embedded in the tapes 152, 156 during consolidation thereof such that a preform 614 is formed.

In another embodiment, as shown in FIG. 19, a rod 802 may be utilized to position a tape 152, 156 or tapes 152, 156 between the impregnation die(s) 150 and consolidation die 650. For example, the rod 802 may extend generally transversely to the path of travel of the tapes 152, 156. Tapes 152, 156, or portions of tapes 152, 156 such as separated impregnated fibers or rovings, may be alternated over and under the rod 802 to position the tape(s) 152, 156. Sensing elements 500 may be provided between the spaced apart tape(s) 152, 156, as shown, as the tape(s) 152, 156 and sensing elements 500 enter the consolidation die 650, the spaced apart tape(s) 152, 156 being consolidated together to enter the consolidation die 650 may orient the sensing element 500, such as to the center of the tape(s) 152, 156 and resulting preform 614. As discussed above, consolidation of the one or more tapes 152, 156 may occur within the die 650 and passage 651 thereof, and the sensing element 500 may accordingly be embedded in the tapes 152, 156 during consolidation thereof such that a preform 614 is formed.

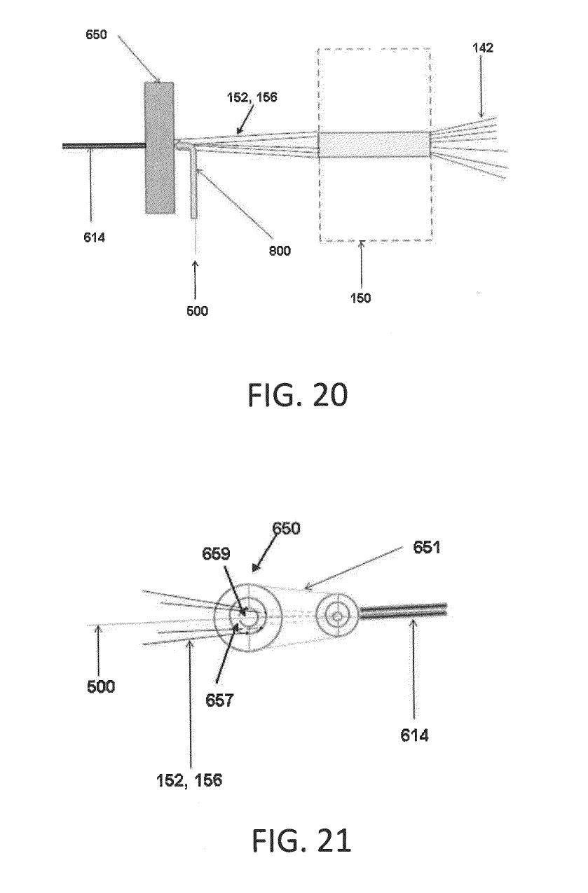

In another embodiment, as shown in FIG. 20, tube 800 be positioned such that it need not extend through impregnation die 150, and rather may provide sensing element 500 directly to consolidation die 650. Similar to the embodiment discussed with respect to FIG. 18, the tube 800 may allow the sensing element 500 to exit therefrom within the downstream die 650. Within the downstream die 650, the sensing element 500 after exiting the tube 800 may become embedded in the preform 614.

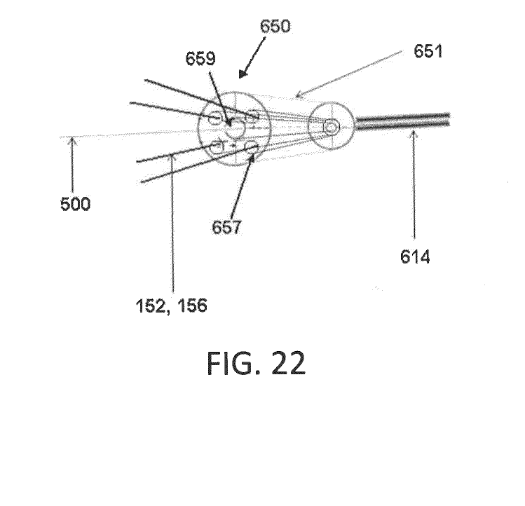

In another embodiment, as shown in FIGS. 21 and 22, a die, such as die 650 as shown or die 660, may include passages having a plurality of separate portions. For example, as shown, die 650 may include passages 651. Each passage 651 may include an outer generally annular passage 657 (see FIG. 21) or a plurality of outer passages 657 (see FIG. 22) arranged in a generally annular array. As shown in FIG. 22, the plurality of outer passages 657 may merge into a single annular passage 657 between the inlet and outlet of the die 650. Alternatively, each of the plurality of outer passages 657 may remain separate. Each passage 651 may further include an inner passage 658 nested within the outer generally annular passage(s) 657. The tapes 152, 156 or impregnated tows may pass through the generally annular passage(s) 657 for consolidation or calibration thereof, while sensing elements 500 may pass through the inner passage 658 to be oriented within the resulting preform 614. Further consolidation and/or calibration of the preform 614 may then occur in downstream dies 650, 660.

A sensing element 500 can be embedded in a tape 152, 156 to form a tape 158, or embedded in a preform 614, in a bonded or unbonded state using any of the above disclosed methods and apparatus. Additionally or alternatively, to facilitate a bonded or unbonded state, the temperature of the sensing element 500 relative to the tape 152, 156 or preform 614 may be a critical factor, as well as the use of a capping layer for the sensing element 500. For example, with respect to temperature, in embodiments wherein bonding is desired, the sensing element 500 and/or capping layer thereof may be heated such that the sensing element 500 and/or capping layer is at a temperature at or above the temperature of the resin in the tape 152, 156 or preform 614 during embedding thereof. In embodiments wherein bonding is not desired, and an unbonded state is instead preferred, the sensing element 500 and/or capping layer thereof may be heated (or not heated) such that the sensing element 500 and/or capping layer is at a temperature below the temperature of the resin in the tape 152, 156 or preform 614 during embedding thereof.

Further, in some embodiments, a capping layer 502 may be provided on a sensing element 500, and may thus generally surround the sensing element 500. The capping layer 502 may facilitate bonding of the capping layer 502 to the tape 152, 156 or preform 614, or alternatively may facilitate non-bonding of the capping layer 502 to the tape 152, 156, as desired. For example, if bonding is desired, a suitable thermoplastic material, which may be identical to the resin thermoplastic material of the tape 152, 156 or preform 614 or have good bonding qualities with the resin material, may be utilized as a capping layer 502. If bonding is not desired, a suitable thermoplastic material, which may not have good bonding qualities with and may thus be dissimilar from the resin material, may be utilized. Alternatively, if bonding is not desired, a suitable lubricant may be included in the capping layer.

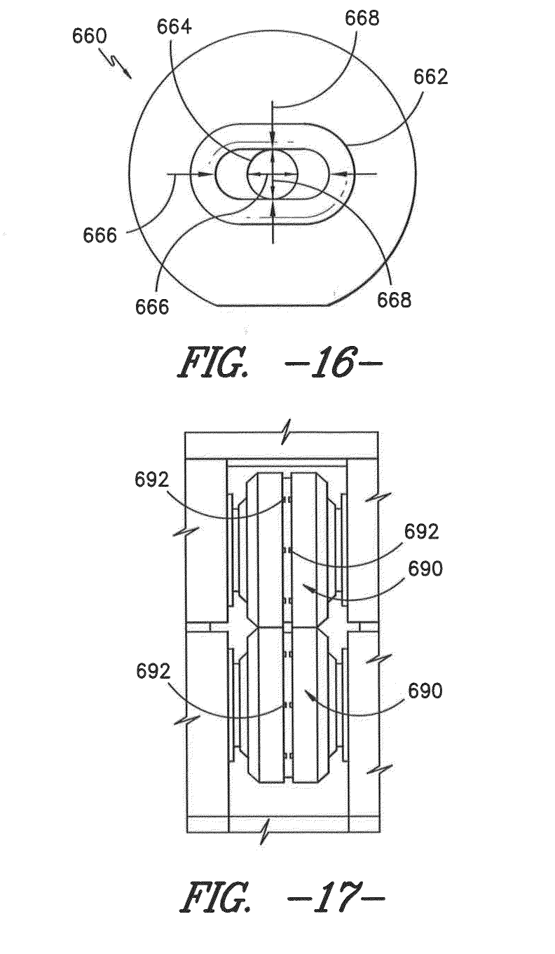

In addition to the use of one or more dies, other mechanisms may also be employed to help compress the preform 614 into the shape of a rod 750. For example, forming rollers 690, as shown in FIG. 17, may be employed between the consolidation die 650 and the calibration die 660, between the various calibration dies 660, and/or after the calibration dies 660 to further compress the preform 614 before it is converted into its final shape. The rollers may have any configuration, such as pinch rollers, overlapping rollers, etc., and may be vertical as shown or horizontal rollers. Depending on the roller 690 configuration, the surfaces of the rollers 690 may be machined to impart the dimensions of the final product, such as the rod, profile, or other suitable product, to the preform 614. In exemplary embodiment, the pressure of the rollers 690 should be adjustable to optimize the quality of the final product.

The rollers 690 in exemplary embodiments, such as at least the portions contacting the material, may have generally smooth surfaces. For example, relatively hard, polished surfaces are desired in many embodiments. For example, the surface of the rollers may be formed from a relatively smooth chrome or other suitable material. This allows the rollers 690 to manipulate the preform 614 without damaging or undesirably altering the preform 614. For example, such surfaces may prevent the material from sticking to the rollers, and the rollers may impart smooth surfaces onto the materials.

In some embodiments, the temperature of the rollers 690 is controlled. This may be accomplished by heating of the rollers 690 themselves, or by placing the rollers 690 in a temperature controlled environment.

Further, in some embodiments, surface features 692 may be provided on the rollers 690. The surface features 692 may guide and/or control the preform 614 in one or more directions as it is passed through the rollers. For example, surface features 692 may be provided to prevent the preform 614 from folding over on itself as it is passed through the rollers 690. Thus, the surface features 692 may guide and control deformation of the preform 614 in the cross-machine direction relative to the machine direction A as well as in the vertical direction relative to the machine direction A. The preform 614 may thus be pushed together in the cross-machine direction, rather than folded over on itself, as it is passed through the rollers 690 in the machine direction A.

In some embodiments, tension regulation devices may be provided in communication with the rollers. These devices may be utilized with the rollers to apply tension to the preform 614 in the machine direction, cross-machine direction, and/or vertical direction to further guide and/or control the preform.

As indicated above, the resulting rod is also applied with a capping layer to protect it from environmental conditions or to improve wear resistance. Referring again to FIG. 13, for example, such a capping layer may be applied via an extruder oriented at any desired angle to introduce a thermoplastic resin into a capping die 672. To help prevent a galvanic response, it is typically desired that the capping material has a dielectric strength of at least about 1 kilivolt per millimeter (kV/mm), in some embodiments at least about 2 kV/mm, in some embodiments from about 3 kV/mm to about 50 kV/mm, and in some embodiments, from about 4 kV/mm to about 30 kV/mm, such as determined in accordance with ASTM D149-09. Suitable thermoplastic polymers for this purpose may include, for instance, polyolefins (e.g., polypropylene, propylene-ethylene copolymers, etc.), polyesters (e.g., polybutylene terephalate (“PBT”)), polycarbonates, polyamides (e.g., Nylon™), polyether ketones (e.g., polyetherether ketone (“PEEK”)), polyetherimides, polyarylene ketones (e.g., polyphenylene diketone (“PPDK”)), liquid crystal polymers, polyarylene sulfides (e.g., polyphenylene sulfide (“PPS”), poly(biphenylene sulfide ketone), poly(phenylene sulfide diketone), poly(biphenylene sulfide), etc.), fluoropolymers (e.g., polytetrafluoroethylene-perfluoromethylvinylether polymer, perfluoro-alkoxyalkane polymer, petrafluoroethylene polymer, ethylene-tetrafluoroethylene polymer, etc.), polyacetals, polyurethanes, polycarbonates, styrenic polymers (e.g., acrylonitrile butadiene styrene (“ABS”)), acrylic polymers, polyvinyl chloride (PVC), etc. Particularly suitable high dielectric strength capping layer materials may include polyketone (e.g., polyetherether ketone (“PEEK”)), polysulfide polyarylene sulfide), or a mixture thereof.

The capping layer is generally free of continuous fibers. That is, the capping layer contains less than about 10 wt. % of continuous fibers, in some embodiments about 5 wt. % or less of continuous fibers, and in some embodiments, about 1 wt. % or less of continuous fibers (e.g., 0 wt. %). Nevertheless, the capping layer may contain other additives for improving the final properties of the rod. Additive materials employed at this stage may include those that are not suitable for incorporating into the continuous fiber material. For instance, it may be desirable to add pigments to reduce finishing labor, or it may be desirable to add flame retardant agents to enhance the flame retarding features of the rod. Because many additive materials are heat sensitive, an excessive amount of heat may cause them to decompose and produce volatile gases. Therefore, if a heat sensitive additive material is extruded with an impregnation resin under high heating conditions, the result may be a complete degradation of the additive material. Additive materials may include, for instance, mineral reinforcing agents, lubricants, flame retardants, blowing agents, foaming agents, ultraviolet light resistant agents, thermal stabilizers, pigments, and combinations thereof. Suitable mineral reinforcing agents may include, for instance, calcium carbonate, silica, mica, clays, talc, calcium silicate, graphite, calcium silicate, alumina trihydrate, barium ferrite, and combinations thereof.

While not shown in detail herein, the capping die 672 may include various features known in the art to help achieve the desired application of the capping layer. For instance, the capping die 672 may include an entrance guide that aligns the incoming rod. The capping die may also include a heating mechanism (e.g., heated plate) that pre-heats the rod before application of the capping layer to help ensure adequate bonding. Following capping, the shaped part 615, or rod 750, is then finally cooled using a cooling system 680 as is known in the art. The cooling system 680 may, for instance, be a sizing system that includes one or more blocks (e.g., aluminum blocks) that completely encapsulate the rod while a vacuum pulls the hot shape out against its walls as it cools. A cooling medium may be supplied to the sizer, such as air or water, to solidify the rod in the correct shape.

Even if a sizing system is not employed, it is generally desired to cool the rod 750 after it exits the capping die (or the consolidation or calibration die if capping is not applied). Cooling may occur using any technique known in the art, such a water tank, cool air stream or air jet, cooling jacket, an internal cooling channel, cooling fluid circulation channels, etc. Regardless, the temperature at which the material is cooled is usually controlled to achieve optimal mechanical properties, part dimensional tolerances, good processing, and an aesthetically pleasing composite. For instance, if the temperature of the cooling station is too high, the material might swell in the tool and interrupt the process. For semi-crystalline materials, too low of a temperature can likewise cause the material to cool down too rapidly and not allow complete crystallization, thereby jeopardizing the mechanical and chemical resistance properties of the composite. Multiple cooling die sections with independent temperature control can be utilized to impart the optimal balance of processing and performance attributes. In one particular embodiment, for example, a water tank is employed that is kept at a temperature of from about 0° C. to about 30° C., in some embodiments from about 1° C. to about 20° C., and in some embodiments, from about 2° C. to about 15° C.

If desired, one or more sizing blocks (not shown) may also be employed, such as after capping. Such blocks contain openings that are cut to the exact rod shape, graduated from oversized at first to the final rod shape. As the rod passes therethrough, any tendency for it to move or sag is counteracted, and it is pushed back (repeatedly) to its correct shape. Once sized, the rod may be cut to the desired length at a cutting station (not shown), such as with a cut-off saw capable of performing cross-sectional cuts or the rod can be wound on a reel in a continuous process. The length of rod will then be limited to the length of the fiber tow.

As will be appreciated, the temperature of the rod as it advances through any section of the system of the present invention may be controlled to yield optimal manufacturing and desired final composite properties. Any or all of the assembly sections may be temperature controlled utilizing electrical cartridge heaters, circulated fluid cooling, etc., or any other temperature controlling device known to those skilled in the art.

Referring again to FIG. 13, a pulling device 682 is positioned downstream from the cooling system 680 that pulls the finished 750 through the system for final sizing of the composite. The pulling device 682 may be any device capable of pulling the rod through the process system at a desired rate. Typical pulling devices include, for example, caterpillar pullers and reciprocating pullers.

The tapes 158 and rods 750 that result from use of dies and methods according to the present disclosure may have a very low void fraction, which helps enhance their strength. For instance, the void fraction may be about 5% or less, in some embodiments about 4% or less, in some embodiments about 3% or less, in some embodiments about 2% or less, in some embodiments about 1.5% or less, in some embodiments about 1% or less, and in some embodiments, about 0.5% or less. The void fraction may be measured using techniques well known to those skilled in the art. For example, the void fraction may be measured using a “resin burn off” test in which samples are placed in an oven (e.g., at 600° C. for 3 hours) to burn out the resin. The mass of the remaining fibers may then be measured to calculate the weight and volume fractions. Such “burn off” testing may be performed in accordance with ASTM D 2584-08 to determine the weights of the fibers and the polymer matrix, which may then be used to calculate the “void fraction” based on the following equations:

V_{f}=100*(ρₜ−ρ_{c})/ρₜ

where,

V_{f} is the void fraction as a percentage;

ρ_{c} is the density of the composite as measured using known techniques, such as with a liquid or gas pycnometer (e.g., helium pycnometer);

ρₜ is the theoretical density of the composite as is determined by the following equation:

ρₜ=1/[Wₜ/ρ_{f}+Wₘ/ρₘ]

ρₘ is the density of the polymer matrix (e.g., at the appropriate crystallinity);

ρ_{f} is the density of the fibers;

W_{f} is the weight fraction of the fibers; and

Wₘ is the weight fraction of the polymer matrix.

Alternatively, the void fraction may be determined by chemically dissolving the resin in accordance with ASTM D 3171-09. The “burn off” and “dissolution” methods are particularly suitable for glass fibers, which are generally resistant to melting and chemical dissolution. In other cases, however, the void fraction may be indirectly calculated based on the densities of the polymer, fibers, tape and/or rod in accordance with ASTM D 2734-09 (Method A), where the densities may be determined ASTM D792-08 Method A. Of course, the void fraction can also be estimated using conventional microscopy equipment.

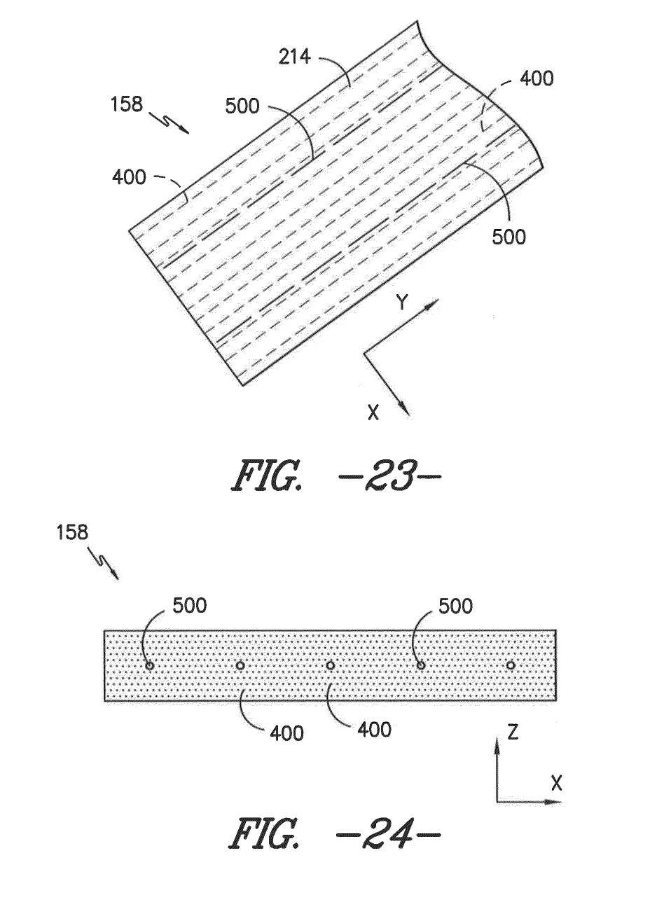

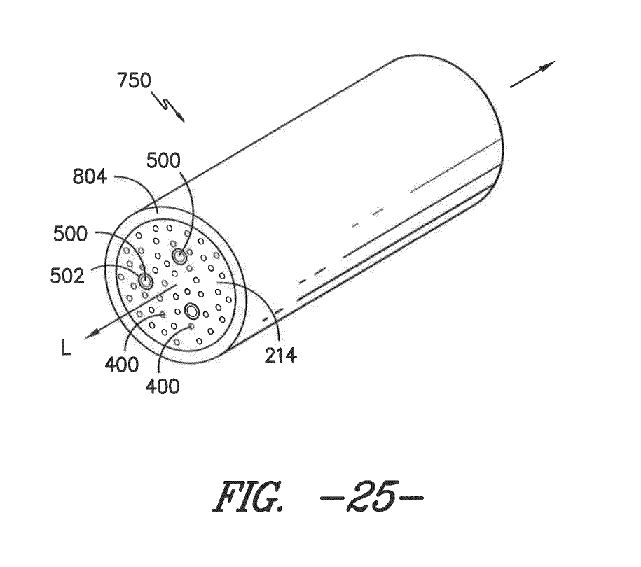

As discussed above, after exiting an impregnation die 150, 412, the CFRT material may in some embodiments form a tape 158. The number of rovings employed in each tape 158 may vary. Typically, however, a tape 158 will contain from 2 to 80 rovings, and in some embodiments from 10 to 60 rovings, and in some embodiments, from 20 to 50 rovings. In some embodiments, it may be desired that the rovings are spaced apart approximately the same distance from each other within the tape 158. In other embodiments, however, it may be desired that the rovings are combined, such that the fibers of the rovings are generally evenly distributed throughout the tape 158, such as throughout one or more resin rich portions and a fiber rich portion as discussed above. In these embodiments, the rovings may be generally indistinguishable from each other. Referring to FIGS. 23 and 24, for example, embodiments of a tape 158 are shown that contains rovings that are combined such that the fibers 400 are generally evenly distributed therein. As shown in FIG. 18, in exemplary embodiments, the fibers extend generally unidirectionally, such as along a longitudinal axis of the tape 158.

One embodiment of a composite rod 750 formed from the method described above is shown in more detail in FIG. 25. As illustrated, the rod 750 has a generally circular shape and includes a core formed from one or more consolidated rovings 142 as discussed herein. By “generally circular”, it is generally meant that the aspect ratio of the rod (height divided by the width) is typically from about 1.0 to about 1.5, and in some embodiments, about 1.0. Due to the selective control over the process used to impregnate the rovings and form tapes 158, as well the process for compressing and shaping the tow into a preform and finally into a rod, as discussed above, the rod 750 may possess a relatively even distribution of resin 214 across along its entire length. This also means that the continuous fibers are distributed in a generally uniform manner about a longitudinal central axis “L” of the rod 750. As shown in FIG. 25, for example, the rod 750 includes continuous fibers 400 embedded within a thermoplastic matrix 214. The fibers 400 are distributed generally uniformly about the longitudinal axis “L.” It should be understood that only a few fibers are shown in FIG. 25, and that the rod 750 will typically contain a substantially greater number of uniformly distributed fibers.

A capping layer 804 formed from capping resin 800 may also extends around the perimeter of the rod 750 and define an external surface of the rod 750. The cross-sectional thickness (“T”) of the rod 750 may be strategically selected to help achieve a particular strength. For example, the rod 750 may have a thickness (e.g., diameter) of from about 0.1 to about 40 millimeters, in some embodiments from about 0.5 to about 30 millimeters, and in some embodiments, from about 1 to about 10 millimeters. The thickness of the capping layer 804 depends on the intended function of the part, but is typically from about 0.01 to about 10 millimeters, and in some embodiments, from about 0.02 to about 5 millimeters. Regardless, the total cross-sectional thickness or height of the rod typically ranges from about of from about 0.1 to about 50 millimeters, in some embodiments from about 0.5 to about 40 millimeters, and in some embodiments, from about 1 to about 20 millimeters. While the rod 750 may be substantially continuous in length, the length of the rod is often practically limited by the spool onto which it will be wound and stored or the length of the continuous fibers. For example, the length often ranges from about 1000 to about 5000 meters, although even greater lengths are certainly possible.

Through use of apparatus and methods according to the present disclosure and control over the various parameters mentioned above, tapes and rods having a very high strength may be formed. For example, the rods may exhibit a relatively high flexural modulus. The term “flexural modulus” generally refers to the ratio of stress to strain in flexural deformation (units of force per area), or the tendency for a material to bend. It is determined from the slope of a stress-strain curve produced by a “three point flexural” test (such as ASTM D790-10, Procedure A), typically at room temperature. For example, the rod of the present invention may exhibit a flexural modulus of from about 10 Gigapascals (“GPa”) or more, in some embodiments from about 12 to about 400 GPa, in some embodiments from about 15 to about 200 GPa, and in some embodiments, from about 20 to about 150 GPa. Furthermore, the ultimate tensile strength may be about 300 Megapascals (“MPa”) or more, in some embodiments from about 400 MPa to about 5,000 MPa, and in some embodiments, from about 500 MPa to about 3,500 MPa. The term “ultimate tensile strength” generally refers to the maximum stress that a material can withstand while being stretched or pulled before necking and is the maximum stress reached on a stress-strain curve produced by a tensile test (such as ASTM D3916-08) at room temperature. The tensile modulus of elasticity may also be about 50 GPa or more, in some embodiments from about 70 GPa to about 500 GPa, and in some embodiments, from about 100 GPa to about 300 GPa. The term “tensile modulus of elasticity” generally refers to the ratio of tensile stress over tensile strain and is the slope of a stress-strain curve produced by a tensile test (such as ASTM 3916-08) at room temperature. Notably, the strength properties of the composite rod referenced above may also be maintained over a relatively wide temperature range, such as from about −40° C. to about 300° C., and particularly from about 180° C. to 200° C.

Rods made according to the present disclosure may further have relatively high flexural fatigue life, and may exhibit relatively high residual strength. Flexural fatigue life and residual flexural strength may be determined based on a “three point flexural fatigue” test (such as ASTM D790, typically at room temperature. For example, the rods of the present invention may exhibit residual flexural strength after one million cycles at 160 Newtons (“N”) or 180 N loads of from about 60 kilograms per square inch (“ksi”) to about 115 ksi, in some embodiments about 70 ksi to about 115 ksi, and in some embodiments about 95 ksi to about 115 ksi. Further, the rods may exhibit relatively minimal reductions in flexural strength. For example, rods having void fractions of about 4% or less, in some embodiments about 3% or less, may exhibit reductions in flexural strength after three point flexural fatigue testing of about 1% (for example, from a maximum pristine flexural strength of about 106 ksi to a maximum residual flexural strength of about 105 ksi). Flexural strength may be tested before and after fatigue testing using, for example, a three point flexural test as discussed above.

The linear thermal expansion coefficient of the composite rod may be, on a ppm basis per ° C., less than about 5, less than about 4, less than about 3, or less than about 2. For instance, the coefficient (ppm/° C.) may be in a range from about −0.25 to about 5; alternatively, from about −0.17 to about 4; alternatively, from about −0.17 to about 3; alternatively, from about −0.17 to about 2; or alternatively, from about 0.29 to about 1.18. The temperature range contemplated for this linear thermal expansion coefficient may be generally in the −50° C. to 200° C. range, the 0° C. to 200° C. range, the 0° C. to 175° C. range, or the 25° C. to 150° C. range. The linear thermal expansion coefficient is measured in the longitudinal direction. i.e., along the length of the fibers.

The composite rod may also exhibit a relatively small “bend radius”, which is the minimum radius that the rod can be bent without breaking and is measured to the inside curvature of the rod. A smaller bend radius means that the rod is more flexible and can be spooled onto a smaller diameter bobbin. This property also makes the rod easier to implement in processes that currently use metal rods. Due to the improved process and resulting rod of the present invention, bend radiuses may be achieved that are less than about 40 times the outer diameter of the rod, in some embodiments from about 1 to about 30 times the outer diameter of the rod, and in some embodiments, from about 2 to about 25 times the outer diameter of the rod, determined at a temperature of about 25° C. For instance, the bend radius may be less than about 15 centimeters, in some embodiments from about 0.5 to about 10 centimeters, and in some embodiments, from about 1 to about 6 centimeters, determined at a temperature of about 25° C.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A composite rod, comprising:
a core, the core comprising:
a thermoplastic material;
a plurality of continuous fibers embedded in the thermoplastic material, the plurality of continuous fibers having a generally unidirectional orientation within the thermoplastic material; and
a sensing element embedded in the thermoplastic material,
wherein the core has a void fraction of about 5% or less.

2. The composite rod of claim 1, further comprising a capping layer generally surrounding the core.

3. The composite rod of claim 2, wherein the capping layer is free of continuous fibers.

4. The composite rod of claim 2, wherein the capping layer contains a thermoplastic polymer having a dielectric strength of at least about 2 KV/mm.

5. The composite rod of claim 1, wherein the continuous fibers are one of carbon fibers, glass fibers, or aramid fibers.

6. The composite rod of claim 1, wherein the sensing element is one of a fiber optic cable, a radio frequency identification transmitter, a copper fiber, or an aluminum fiber.

7. The composite rod of claim 1, wherein the fibers have a ratio of ultimate tensile strength to mass per unit length of greater than about 1,000 Megapascals per gram per meter.

8. The composite rod of claim 1, wherein the continuous fibers constitute from about 25 wt. % to about 80 wt. % of the rod and the thermoplastic material constitutes from about 20 wt. % to about 75 wt. % of the rod.

9. The composite rod of claim 1, wherein the rod has a minimum flexural modulus of about 10 Gigapascals.

10. The composite rod of claim 1, wherein the rod has an ultimate tensile strength of about 300 Megapascals or more.

11. The composite rod of claim 1, wherein the rod has a tensile modulus of elasticity of about 50 Gigapascals or more.

12. The composite rod of claim 1, wherein the rod has a diameter of from about 0.1 to about 50 millimeters.

13. The composite rod of claim 1, wherein the rod has a circular cross-sectional shape.

14. The composite rod of claim 1, wherein the sensing element is bonded to the thermoplastic material.

15. The composite rod of claim 1, wherein the sensing element is unbonded from the thermoplastic material.

16. The composite rod of claim 1, wherein a capping layer generally surrounds the sensing element.

17. A composite tape, comprising:
a thermoplastic material;
a plurality of continuous fibers embedded in the thermoplastic material, the plurality of continuous fibers having a generally unidirectional orientation within the thermoplastic material; and
a sensing element embedded in the thermoplastic material.

18. The composite tape of claim 17, wherein the continuous fibers are one of carbon fibers, glass fibers, or aramid fibers.

19. The composite tape of claim 17, wherein the sensing element is one of a fiber optic cable, a radio frequency identification transmitter, a copper fiber, or an aluminum fiber.

20. The composite tape of claim 17, wherein the composite tape has a void fraction of about 5% or less.

21. The composite tape of claim 17, wherein the fibers have a ratio of ultimate tensile strength to mass per unit length of greater than about 1,000 Megapascals per gram per meter.

22. The composite tape of claim 17, wherein the continuous fibers constitute from about 25 wt. % to about 80 wt. % of the tape and the thermoplastic material constitutes from about 20 wt. % to about 75 wt. % of the tape.

23. The composite tape of claim 17, wherein the sensing element is bonded to the thermoplastic material.

24. The composite tape of claim 17, wherein the sensing element is unbonded from the thermoplastic material.

25. The composite tape of claim 17, wherein a capping layer generally surrounds the sensing element.
